(19) United States
(12) Patent Application Publication
(10) Pub. No.: US 2026/0064718 A1
(43) Pub. Date: Mar. 5, 2026

(54) SYSTEM, SYSTEM-IMPLEMENTED METHOD, AND PROGRAM

(71) Applicant: Hitachi, Ltd., Tokyo (JP)

(72) Inventor: Yoji OZAWA, Tokyo (JP)

(21) Appl. No.: 19/205,884

(22) Filed: May 12, 2025

(30) Foreign Application Priority Data
Aug. 27, 2024 (JP) 2024-145771

(51) Int. Cl. G06F 16/28

(52) U.S. Cl. CPC G06F 16/283

(57) ABSTRACT

A system includes a data center operation mode plan creation unit that creates a data center operation mode plan, which is a plan of an operation mode of each of data centers, based on a prediction regarding a workload. The system may include a workload deployment setting unit that determines the data center to which the workload associated with a received workload execution request is to be deployed based on a condition when the workload associated with the received workload execution request is processed and on the operation mode of each of the data centers determined according to a data center operation mode plan.

### CROSS-REFERENCE TO RELATED APPLICATION

The present application claims priority from Japanese application JP2024-145771, filed on Aug. 27, 2024, the content of which is hereby incorporated by reference into this application.

### BACKGROUND OF THE INVENTION

### 1. Field of the Invention

The present disclosure relates to a technology for efficiently operating an information processing resource for processing a workload.

### 2. Description of the Related Art

One or more workloads (such as tasks to be subjected to information processing) are deployed to some information processing resources, and then the information processing resources process the workloads. For example, an information processing resource (for example, a resource such as a central processing unit (CPU), a graphics processing unit (GPU), or a memory) of a server group on a cloud is allocated to a workload of training processing for training (a model parameter of) a model by machine learning or a workload of inference processing for performing inference using a trained model, and the information processing resource processes the workload after the workload is deployed.

Hitherto, some efficiency improvement or the like has been considered in relation to processing of a workload using an information processing resource.

For example, U.S. Pat. No. 10,034,417 discloses a technology for minimizing energy consumption of a cooling device while maintaining a temperature within an allowable range by performing a simulation for a temperature or the like in a data center having an information processing resource for processing a workload in response to setting of arrangement of the workload.

In addition, for example, US 2023/0035310 A discloses a technology for allocating each workload to each host in consideration of a specification (for example, a required hardware accelerator specification) of an information processing resource for executing a workload and a maintenance schedule of each host that is a candidate of a destination to which the workload is allocated.

### SUMMARY OF THE INVENTION

There is much room for improvement in efficiency in processing a workload by an information processing resource.

Since the technology disclosed in U.S. Pat. No. 10,163,031 described above is intended to collectively control the entire information processing resources that perform processing of a workload, setting of control of a facility that provides the information processing resources tends to be complicated, and it is difficult to perform precise control.

In addition, in the technology disclosed in U.S. Pat. No. 10,163,031, emphasis is placed on the control of the facility that provides the information processing resources that process a workload, and emphasis is not placed on control of a workload. Therefore, in the technology disclosed in U.S. Pat. No. 10,163,031, if an attempt is made to control a workload, it is assumed that the control of the workload tends to be complicated and it is difficult to perform fine control.

The technology disclosed in US 2023/0035310 A described above is intended to allocate a workload to a host in a situation where control regarding the information processing resources is generally determined although there is room for some adjustment regarding the maintenance schedule of the host. Therefore, in the technology disclosed in US 2023/0035310 A, it can be said that the control of the facility that provides the information processing resources is not so emphasized. That is, in the technology disclosed in US 2023/0035310 A, if an attempt is made to set the facility that provides the information processing resources, it is assumed that the setting tends to be complicated and it is difficult to perform fine control.

In addition, in the technology disclosed in US 2023/0035310 A, the specification of the information processing resource for executing a workload is considered when allocating the workload to a host, but it is considered that a specification itself of a computer resource provided by the host when each of the hosts that are allocation destinations is operating is unique to the host, and it is not assumed that the specification of the computer resource provided by the host is dynamically adjusted. As described above, control of allocation of a workload to a host in the technology disclosed in US 2023/0035310 A is not flexible.

In this regard, an object of the present disclosure may be to perform simple control and fine control for both of control of a facility that provides an information processing resource and control for allocation (deployment) of a workload to the information processing resource in processing the workload by the information processing resource.

When the object of the present disclosure is achieved, it is possible to simply and finely control the facility that provides the information processing resource that processes the workload according to a state of the workload to be processed. That is, it is possible to operate the facility that provides the information processing resource with necessary and sufficient quality or quantity.

Furthermore, when the object of the present disclosure is achieved, at the time of allocating the information processing resource to the workload, it is possible to simply and finely perform control regarding an allocation destination of the workload among the information processing resources in which the quality or quantity of the providable resource is finely controlled. That is, highly flexible operation can be performed regarding allocation of the information processing resource to the workload.

In order to achieve at least one of the above objects, features of the present disclosure are, for example, as follows.

One aspect of the present disclosure is a system. The system includes a data center operation mode plan creation unit that creates a data center operation mode plan, which is a plan of an operation mode of each of data centers, based on a prediction regarding a workload requested to be processed in any one of the data centers.

As described above, the present disclosure determines the plan of the operation mode of each of the data centers that are candidates for processing the workload based on a prediction regarding the workload. As described above, in the present disclosure, since the operation mode is determined for each data center, it is possible to simply and finely control the facility that provides the information processing resource that processes the workload. In addition, since the present disclosure determines the operation mode for each data center based on a prediction regarding the workload, it is possible to operate the facility that provides the information processing resource with necessary and sufficient quality or quantity.

Furthermore, in the present disclosure, since the operation mode is determined for each data center, when allocating the information processing resource to the workload, it is possible to simply and finely perform control regarding an allocation destination of the workload among the information processing resources in each data center in which the quality or quantity of the providable resource is finely controlled according to the operation mode.

As described above, in the present disclosure, it is possible to perform simple control and fine control for both of control of the facility that provides the information processing resource and control for allocation (deployment) of the workload to the information processing resource in processing the workload by the information processing resource.

A method and a program that implement the same processing as that implemented by the above-described system can also obtain the same operation and effect as those of the above-described system. In the case of an aspect of the program, costs are often reduced. In the case of the program, design change related to processing is also easily performed.

Features of the present disclosure other than the above and operations and effects corresponding to the features are disclosed in the specification, claims, or drawings.

### BRIEF DESCRIPTION OF THE DRAWINGS

FIG. 1 illustrates a basic functional configuration of an embodiment of the present disclosure;

FIG. 2 illustrates an overall configuration including a system according to the embodiment of the present disclosure;

FIG. 3 illustrates a configuration around a data center;

FIG. 4 illustrates a functional configuration of a data center control system;

FIG. 5 illustrates a functional configuration of the system;

FIG. 6 illustrates a data center list table;

FIG. 7 illustrates a data center operation mode list table;

FIG. 8 illustrates a workload actual record table;

FIG. 9 illustrates a workload prediction table;

FIG. 10 illustrates a data center operation mode plan table;

FIG. 11 illustrates a workload execution request buffer table;

FIG. 12 illustrates a workload deployment setting table;

FIG. 13 illustrates a workload execution history table;

FIG. 14 illustrates a workload redeployment setting table;

FIG. 15 illustrates a computer architecture for implementing the system;

FIG. 16 illustrates processing in a workload actual record table creation unit;

FIG. 17 illustrates processing in a workload prediction unit;

FIG. 18 illustrates processing in a data center operation mode plan creation unit;

FIG. 19 illustrates processing in a workload deployment setting unit;

FIG. 20 illustrates processing in a workload redeployment setting unit; and

FIG. 21 illustrates a modified data center list table.

### DESCRIPTION OF THE PREFERRED EMBODIMENTS

Hereinafter, embodiments of the present disclosure will be described in detail with reference to the drawings. Note that the embodiments described below do not limit the disclosure according to the claims, and all of the elements described in the embodiments and combinations thereof are not necessarily essential to the solution of the disclosure. The following description and drawings are examples for describing the present disclosure, and omission and simplification are appropriately made for clarity of description. The present disclosure can be carried out in various other forms. Unless otherwise specified, each component may be plural or singular. The position, size, shape, range, and the like of each component illustrated in the drawings do not represent the actual position, size, shape, range, and the like in some cases in order to facilitate understanding of the invention. Therefore, the present disclosure is not necessarily limited to the position, size, shape, range, and the like disclosed in the drawings.

Each of a system, a device, and a functional unit according to the present disclosure may be integrated in hardware, or may be divided into a plurality of portions and the portions may play a role in cooperation with each other. Several systems, devices, or functional units may be integrated in hardware.

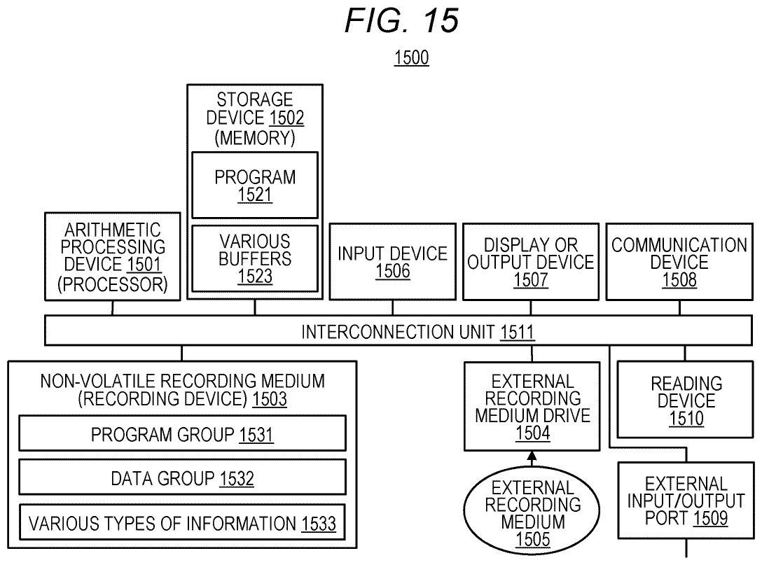

Each of the system, the device, or the functional unit may be implemented by causing a computer to execute software (program) (as illustrated in FIG. 15). Some of functions of the system, the device, or the functional unit may be implemented by hardware (for example, a hardwired logic or a field programmable gate array (FPGA)), and the remaining functions may be implemented by executing software (program). All of the functions of the system, the device, or the functional unit may be implemented in hardware. Some or all of steps illustrated in the flowcharts or the like described in the present disclosure may be implemented in hardware.

Each of one or more systems, devices, or functional units of the present disclosure may be implemented from one or more hardware resources. Therefore, each of the systems, devices, or functional units of the present disclosure may be implemented virtually. For example, methods such as a virtual computer and a virtual container method may be used.

The program may be any program as long as the program is included in a concept including general ones corresponding to software in which a specific system or an operation method thereof according to a use purpose is constructed by cooperation of software and hardware resources. That is, the program is not limited to a program of a specific type or aspect. In addition, the program may be initially recorded in a compressed format.

The same reference numerals denote the same elements in the drawings. In the drawings illustrating the flowcharts, rectangular boxes indicate steps of processing and hexagonal boxes indicate steps of conditional branching. In the drawings illustrating the flowcharts, “step” is abbreviated as “S”.

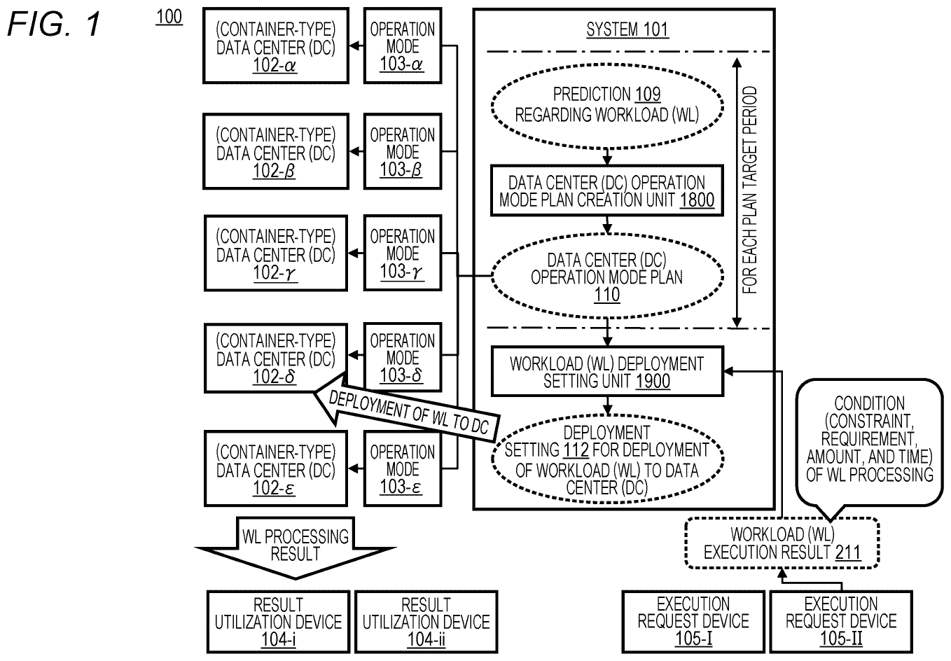

### 1. BASIC FUNCTIONAL CONFIGURATION (FIG. 1)

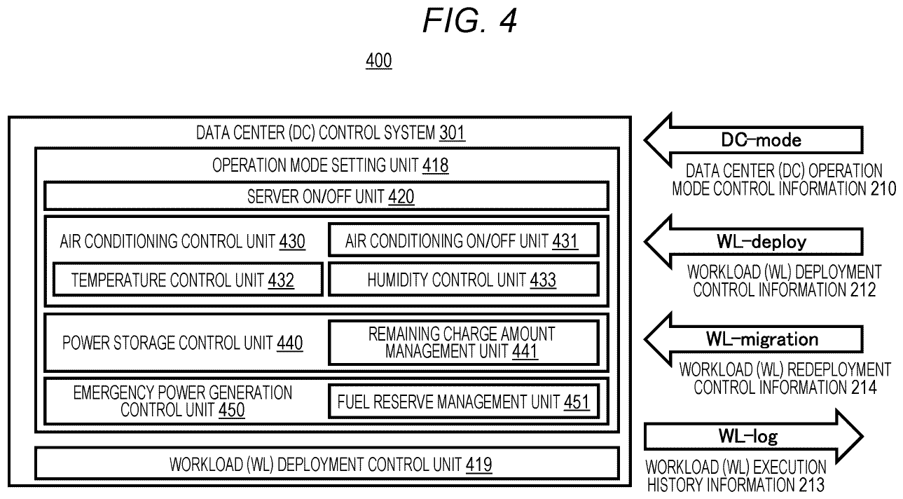

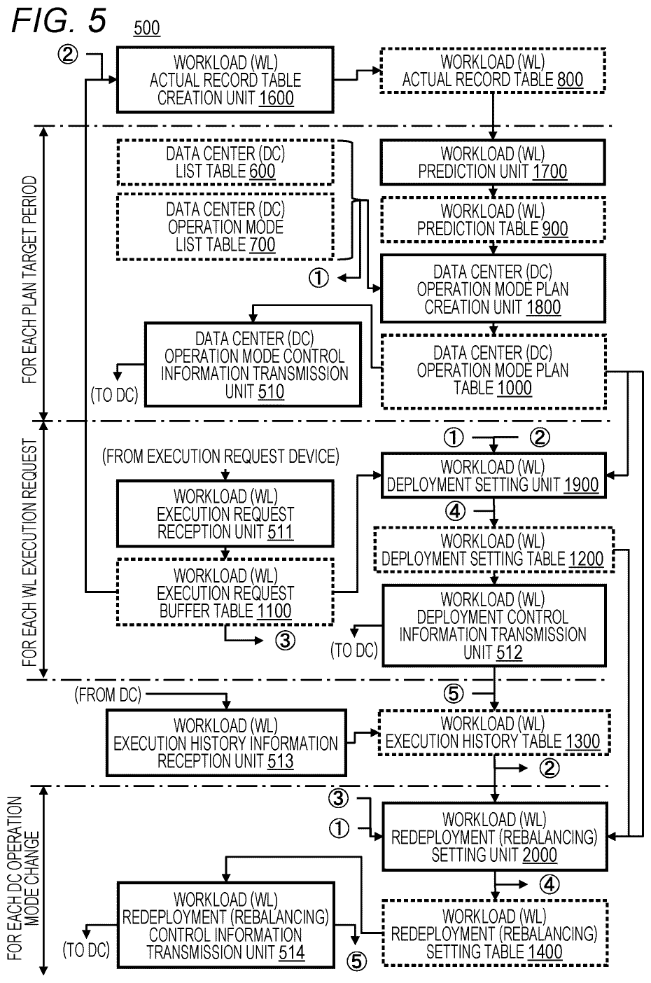

FIG. 1 illustrates a basic functional configuration 100 (or handled information) of a system 101 according to an embodiment of the present disclosure. Not all the functional configurations illustrated in FIG. 1 are essential. In addition, the existence of a functional configuration other than the functional configuration illustrated in FIG. 1 is not precluded. In FIG. 1 (FIGS. 4 and 5), a solid rectangle with “unit” attached to the name indicates a functional unit.

FIG. 1 illustrates a plurality of data centers 102, a plurality of result utilization devices 104, and a plurality of execution request devices 105 in addition to the system 101 according to the embodiment of the present disclosure. (There may be only one execution request device 105.)

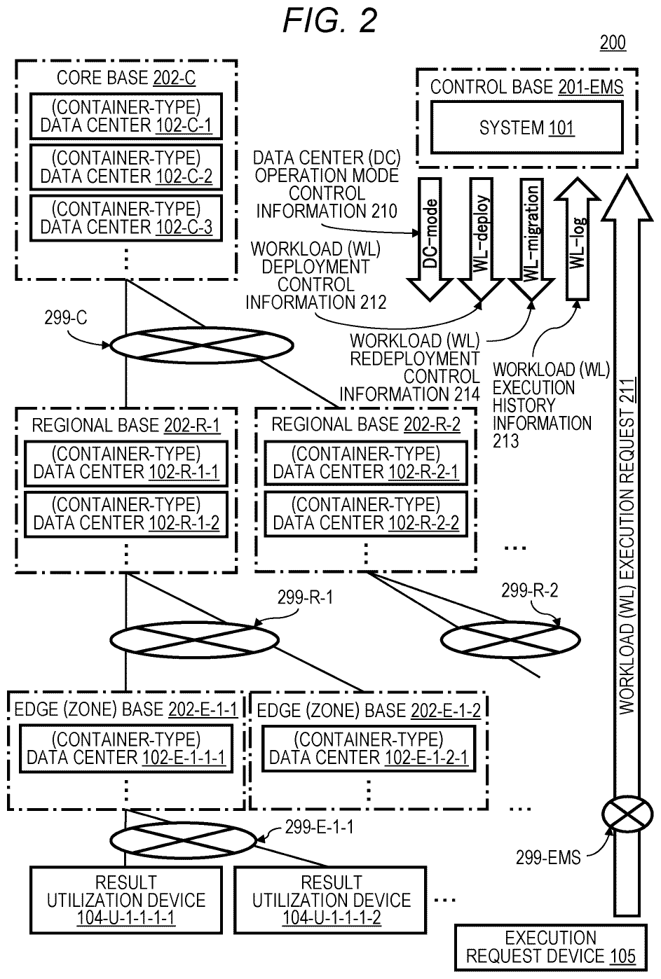

The execution request device 105 is a device serving as an issuing source that issues a workload execution request 211 for requesting processing of a workload. The result utilization device 104 is a device that uses a result of the processing of the workload. Each of the execution request device 105 and the result utilization device 104 may be a user device, may be another type of device, or may be a certain functional unit implemented by executing a program or the like in a certain system, device, or the like. In FIGS. 1 and 2, the result utilization device 104 and the execution request device 105 are illustrated as separate devices, but the result utilization device 104 and the execution request device 105 may be the same device.

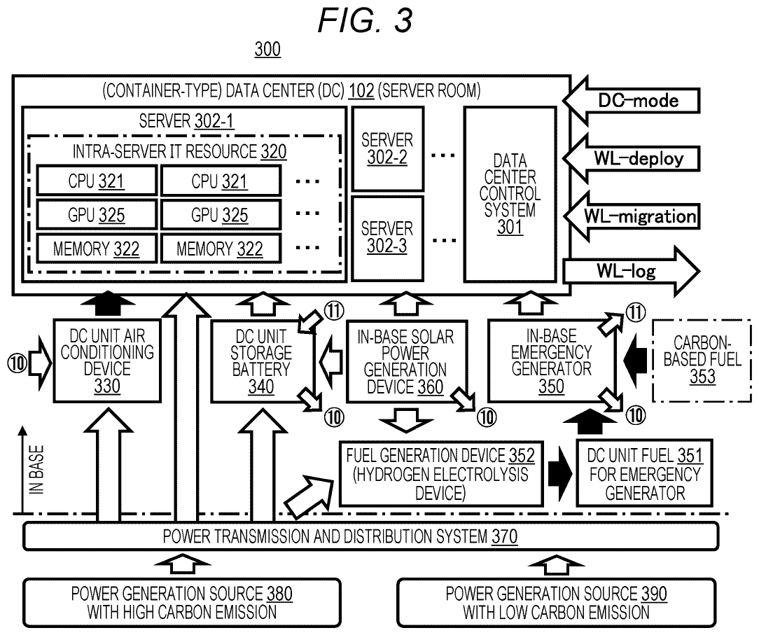

The data center 102 indicates a facility including an information processing resource (for example, a central processing unit (CPU), a graphics processing unit (GPU), or a memory) for processing the workload. Here, the data center 102 may be what is called a container-type data center. The container-type data center may include a plurality of servers including the information processing resources inside a housing space in a container form. In addition, control related to the facility may be performed in units of container-type data centers. Here, the control related to the facility may include one or more of control related to air condition, control related to a storage battery, and control related to an emergency generator. Details of the container-type data center are described below with reference to FIGS. 3 and 4. In the present disclosure, it is sufficient if the facility including the information processing resource can be controlled for each of a certain amount of information processing resources. Therefore, the facility including the information processing resource is not necessarily limited to the container-type data center, and may be another type of data center or any facility other than the data center.

In FIG. 1, any one of the execution request devices 105 issues a workload execution request 211 for requesting the processing of the workload. The workload associated with the issued workload execution request 211 is allocated to any one of the data centers 102, and the workload is deployed to the data center 102 that serves as an allocation destination. The data center 102 to which the workload is deployed performs the processing of the workload.

In a series of handling of the workload illustrated above, the system 101 according to the embodiment of the present disclosure at least serves as a functional unit called a data center operation mode plan creation unit 1800 in FIG. 1. Specifically, the data center operation mode plan creation unit 1800 in the system 101 creates a data center operation mode plan 110, which is a plan of an operation mode 103 of each of the data centers 102, based on a prediction 109 regarding the workload requested to be processed in any one of the data centers 102.

The operation mode 103 set for each of the data centers 102 may be for determining a control content of the facility of the data center 102. The control content of the facility of the data center 102 may influence a content (for example, the type, performance, or amount) and availability of the information processing resource providable by the data center 102. Further, the control content of the facility of the data center 102 may influence various indices (for example, a running cost (a cost at the time of operation), a ratio (green rate) of power generated with a relatively low carbon emission to a power consumption, and an index related to adjustment compensation) related to the data center 102.

That is, if the operation mode 103 is appropriately set for each of the data centers 102, it is possible to achieve both processing of a workload group indicated by the prediction 109 regarding the workload by a data center group without excess or deficiency and improvement in various indices related to the data center 102.

In addition, since the operation mode 103 is set for each data center 102, simple control can be implemented for control of the facility that provides the information processing resource. Furthermore, since the operation mode 103 having a different content can be set for each data center 102, detailed control can be implemented for the control of the facility that provides the information processing resource.

As illustrated in FIG. 1, the system 101 may also perform control in allocating (deploying) the workload to the information processing resource in a centralized manner. For this purpose, the system 101 may include a workload deployment setting unit 1900. The workload deployment setting unit 1900 may, in response to reception of the workload execution request 211 from any one of the execution request devices 105, determine the data center 102 to which the workload associated with the received workload execution request 211 is to be allocated (deployed). As a result of the determination, the workload deployment setting unit 1900 may create a deployment setting 112 for deployment of the workload to the data center. The workload may be deployed to the data center 102 based on the deployment setting 112 for deployment of the workload to the data center.

Here, the workload deployment setting unit 1900 may determine the data center 102 as an allocation destination (deployment destination) of the workload based on a condition when the workload associated with the workload execution request 211 is processed and on the operation mode 103 of each of the data centers 102 determined according to the data center operation mode plan 110.

The condition when the workload is processed may include one or more of a constraint when processing the workload (for example, a constraint indicating the data center 102 to which the workload can be deployed if another condition is satisfied), a requirement when processing the workload (for example, a requirement related to the degree to which processing is not interrupted in the middle of processing the workload (a level of the availability) or a requirement related to the content (for example, the type, performance, or amount) of the information processing resource), a temporal amount of the information processing resource required when processing the workload, and an allowable delay time for a time at which the processing of the workload starts or ends. There may be a condition other than the above.

The operation mode 103 of each of the data centers 102 may be associated with, for example, a providable requirement when processing the workload (for example, a providable requirement related to the degree to which processing is not interrupted in the middle (the level of the availability) when processing the workload, or a providable requirement related to the content (for example, the type, performance, or amount) of the information processing resource).

Therefore, the workload deployment setting unit 1900 can appropriately allocate (deploy) the workload associated with the workload execution request 211 to the data center 102 capable of processing the workload.

Unlike FIG. 1, the system 101 does not have to perform the control in allocating (deploying) the workload to the information processing resource in a centralized manner. It is also possible to implement the control in allocating (deploying) the workload to the information processing resource in a distributed manner. Details are described below as Modified Example A. In this case, the workload deployment setting unit 1900 does not have to exist in the system 101.

Hereinafter, an aspect in which the system 101 performs the control in allocating (deploying) the workload to the information processing resource in a centralized manner will be mainly described in order to simplify the description.

Since the system 101 in the embodiment of the present disclosure has the functional configuration as described above, it is possible to obtain the effects described in [Advantageous Effects of the Invention] described above.

### 2. OVERALL CONFIGURATION INCLUDING SYSTEM 101 (FIG. 2)

FIG. 2 illustrates an overall configuration 200 including the system 101 according to the embodiment of the present disclosure. Not all the functional configurations illustrated in FIG. 2 are essential. In addition, the existence of a functional configuration other than the functional configuration illustrated in FIG. 2 is not precluded.

The plurality of (container-type) data centers 102, the plurality of result utilization devices 104, the one or more execution request devices 105, and the system 101 according to the embodiment of the present disclosure in FIG. 1 may be communicable with each other by a network 299 as illustrated in FIG. 2. Five networks 299 are illustrated in FIG. 2 for convenience of illustration. An actual topology of the network 299 may be arbitrary. It is sufficient if communication entities (for example, the data center 102, the result utilization device 104, the execution request device 105, and the system 101) that actually communicate with each other can communicate with each other, and it is not necessary that all combinations of the data center 102, the result utilization device 104, the execution request device 105, and the system 101 illustrated in FIG. 2 can communicate with each other.

Each of the (container-type) data centers 102 may exist in a certain base 202. The example of FIG. 2 illustrates an aspect in which the plurality of (container-type) data centers 102 are geographically dispersed, and the plurality of (container-type) data centers 102 are hierarchically arranged for each role. Specifically, as illustrated in FIG. 2, there may be a core base 202-C which is a core base for services provided by the plurality of (container-type) data centers 102, a regional base 202-R which is a base for each region, and an edge base 202-E (zone base) which exists in any one of zones narrower than the region. One or more (container-type) data centers 102 may exist in each of the bases 202.

Here, the base 202 geographically closest to a result utilization device 104-U may be the edge base 202-E (zone base) in a zone where the result utilization device 104-U exists. That is, in a case where it is desired that the result utilization device 104-U obtains the result of the processing of the workload associated with the workload execution request 211 as soon as possible, it is often appropriate that (if all the (container-type) data centers 102 require a similar processing time) the workload is allocated (deployed) to a (container-type) data center 102-E existing in the edge base 202-E (zone base) of the zone where the result utilization device 104-U exists.

On the other hand, in terms of the providable requirement (for example, the providable requirement related to the degree to which processing is not interrupted in the middle (the level of the availability) when processing the workload or the providable requirement related to the content (for example, the type, performance, or amount) of the information processing resource) of the (container-type) data center 102 existing in the base 202, the regional base 202-R is often better than the edge base 202-E (zone base), and the core base 202-C is often better than the regional base 202-R. Therefore, the (container-type) data center 102-E (and the operation mode 103 set in the data center 102-E) existing in the edge base 202-E (zone base) does not satisfy the condition in some cases depending on a content of the condition when the workload associated with the workload execution request 211 is processed. In the case of a more severe condition, even a (container-type) data center 102-R (and the operation mode 103 set in the data center 102-R) existing in the regional base 202-R does not satisfy the condition in some cases.

The system 101 which is the embodiment of the present disclosure may exist in a control base 201-energy management system (EMS). Alternatively, the system 101 may exist in other bases illustrated in FIG. 2.

As the system 101 creates the data center operation mode plan 110 (FIG. 1), the system 101 transmits data center operation mode control information 210 (DC-mode) in order to deliver a setting of the operation mode 103 for each data center 102 included in the data center operation mode plan 110 to each data center 102. The data center operation mode control information 210 (DC-mode) includes a setting content of the operation mode 103 related to the data center 102 as a destination of the data center operation mode control information 210 (DC-mode).

In a case where the system 101 performs the control in allocating (deploying) the workload to the information processing resource in a centralized manner, the system 101 transmits workload deployment control information 212 (WL-deploy). The workload deployment control information 212 (WL-deploy) includes information regarding the workload to be allocated (deployed) to the data center 102 as the destination of the workload deployment control information 212 (WL-deploy).

Each of the data centers 102 may transmit workload execution history information 213 (WL-log) which is information regarding an execution history or an execution state related to the processing of the workload as the data center 102 processes the workload. The system 101 may grasp the information regarding the execution history or the execution state related to the processing of the workload in each data center 102 by receiving the workload execution history information 213. The transmission and reception of the workload execution history information 213 (WL-log) may be performed regardless of whether the control in allocating (deploying) the workload to the information processing resource is performed by the system 101 in a centralized manner or by the respective data centers 102 in a distributed manner.

The operation mode 103 may be changed in any one of the data centers 102 according to the control of the operation mode 103 in the data center 102 based on the data center operation mode plan 110 (FIG. 1). Then, the condition when processing the workload and the providable requirement of the data center 102 in the changed operation mode 103 or the like are not satisfied for the workloads that have been deployed to the data center 102 so far in some cases due to the change of the operation mode 103 of the data center 102.

In such a case, the system 101 may transmit workload redeployment control information 214 (WL-migration) to redeploy (rebalance or migrate) the workload that does not satisfy the condition to another data center 102. The workload redeployment control information 214 (WL-migration) includes information for changing the data center 102 to which the workload to be redeployed (rebalanced or migrated) is to be deployed. Both the data center 102 as the deployment destination before the redeployment and the data center 102 as a redeployment destination may receive the workload redeployment control information 214 (WL-migration).

### 3. CONFIGURATION AROUND DATA CENTER (FIGS. 3 AND 4)

FIG. 3 illustrates the (container-type) data center 102 existing in each of the bases 202 illustrated in FIG. 2 and a configuration 300 around the data center 102. Not all the configurations illustrated in FIG. 3 are essential. In addition, the existence of a configuration other than the configuration illustrated in FIG. 3 is not precluded.

FIG. 3 does not illustrate an uninterruptible power supply (UPS) that serves as a buffer for power between various power supplies and the (container-type) data center 102. Further, FIG. 3 does not illustrate a detailed configuration for dual or triple power supply redundancy for the (container-type) data center 102.

The (container-type) data center 102 may serve as a server room and may include a plurality of servers 302 therein. Each of the servers 302 may include an intra-server IT resource 320 as the information processing resource. The intra-server IT resource 320 may include, for example, a central processing unit (CPU) 321, a graphics processing unit (GPU) 325, and a memory 322. Furthermore, the intra-server IT resource 320 may include other types of information processing resources.

Each of the servers 302 included in one (container-type) data center 102 can be individually controlled to be powered on and off. Alternatively, a ratio of the servers 302 to be powered on (a ratio of the servers 302 to be powered off) among the servers 302 included in one (container-type) data center 102 can be controlled. Alternatively, an operating voltage and an operating frequency of each of the servers 302 may be controlled.

The (container-type) data center 102 may include a data center control system 301. Functional units included in the data center control system 301 are illustrated in FIG. 4 (details are described below). The data center control system 301 may perform on/off control of the server 302, control related to air conditioning for the (container-type) data center 102, control related to a storage battery for the (container-type) data center 102, and control related to an emergency generator for the (container-type) data center 102. The data center control system 301 can receive the data center operation mode control information 210 (DC-mode), the workload deployment control information 212 (WL-deploy), and the workload redeployment control information 214 (WL-migration) described in FIG. 2, and can transmit the workload execution history information 213 (WL-log). In FIG. 3, the server 302 and the data center control system 301 are illustrated as being separate from each other, but the data center control system 301 may be constructed by executing a data center control program in any one of the servers 302.

As a facility around the (container-type) data center 102 in the base 202, one or more of a data center unit air conditioning device 330, a data center unit storage battery 340, and a data center unit fuel 351 (for example, hydrogen fuel) for the emergency generator may exist.

In addition, one or more of an in-base emergency generator 350, a fuel generation device 352 (for example, a hydrogen electrolysis device), a carbon-based fuel 353, and an in-base solar power generation device 360 may exist in the base 202. One or more of the emergency generator, the fuel generation device, the carbon-based fuel, and the solar power generation device may also exist in units of data centers.

In FIG. 3, a white arrow without letters indicates a power flow, and a black thick arrow indicates a flow other than the power flow. In addition, the numbers with circles indicate that elements with the same numbers are connected to each other.

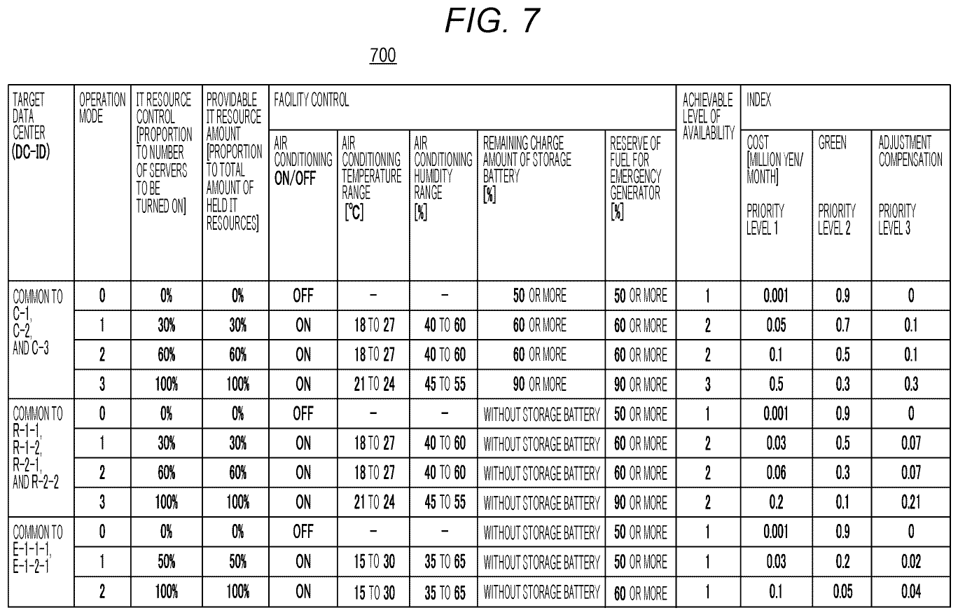

The data center unit air conditioning device 330 adjusts a temperature and a humidity of the (container-type) data center 102 by using power from any one of a power transmission and distribution system 370, the data center unit storage battery 340, the in-base emergency generator 350, and the in-base solar power generation device 360. (In the description of the embodiment of the present disclosure with reference to FIGS. 3, 4, and 7, the air conditioning device is mentioned, but control of the temperature of the data center 102 or the like is not limited to be performed by the air conditioning device. For example, another type of cooling device such as a water cooling device or a liquid cooling device may be used instead of or together with the air conditioning device. In this case, the other type of cooling device may be included as a facility control target illustrated in FIG. 7.)

The data center unit storage battery 340 stores power using the power from any one of the power transmission and distribution system 370, the in-base emergency generator 350, and the in-base solar power generation device 360. The data center unit storage battery 340 can supply the stored power to the (container-type) data center 102.

The in-base emergency generator 350 generates the power by using the data center unit fuel 351 (for example, hydrogen fuel) for the emergency generator, or generates the power by using the carbon-based fuel 353. Alternatively, the in-base emergency generator 350 may use both the fuel 351 (for example, hydrogen fuel) and the carbon-based fuel 353 for power generation. In addition, the in-base emergency generator 350 can supply the generated power to the (container-type) data center 102.

The fuel generation device 352 generates a fuel for the in-base emergency generator 350 by using the power from any one of the power transmission and distribution system 370 and the in-base solar power generation device 360. The fuel generation device 352 may be, for example, a hydrogen electrolysis device. The generated fuel is stored as the data center unit fuel 351 (for example, hydrogen fuel) for the emergency generator.

The in-base solar power generation device 360 can supply the generated power to the (container-type) data center 102.

The power transmitted from the power transmission and distribution system 370 into the base 202 includes one or both of power from a power generation source 380 with a relatively high carbon emission and power from a power generation source 390 with a relatively low carbon emission.

FIG. 4 illustrates a functional configuration 400 of the data center control system 301. In FIG. 4, a solid rectangle with “unit” attached to the name indicates a functional unit. Each functional unit may be constructed by executing a program for the functional unit.

Alternatively, any one of the functional units may be implemented more in hardware. Alternatively, all of the functional units may be implemented more in hardware. Furthermore, in any one of the functional units illustrated in FIG. 4, some functions may be implemented more in hardware, and the remaining functions may be constructed by executing a program.

The data center control system 301 may include an operation mode setting unit 418 and a workload deployment control unit 419 as the functional units. The operation mode setting unit 418 may include a server on/off unit 420, an air conditioning control unit 430, a power storage control unit 440, and an emergency power generation control unit 450 as internal functional units. The air conditioning control unit 430 may include an air conditioning on/off unit 431, a temperature control unit 432, and a humidity control unit 433 as internal functional units. The power storage control unit 440 may include a remaining charge amount management unit 441 as an internal functional unit. The emergency power generation control unit 450 may include a fuel reserve management unit 451 as an internal control unit.

The operation mode setting unit 418 performs setting of the (container-type) data center 102 and a facility around the (container-type) data center 102 according to the operation mode 103 instructed by the data center operation mode control information 210 (DC-mode).

The server on/off unit 420 controls on/off of a power supply of each of the servers 302 according to the operation mode 103. Alternatively, the server on/off unit 420 with an extended function may control the operating voltage and the operating frequency of each of the servers 302 according to the operation mode 103.

The air conditioning control unit 430 controls the data center unit air conditioning device 330 according to the operation mode 103. The air conditioning on/off unit 431 controls on/off of an air conditioning function of the data center unit air conditioning device 330 according to the operation mode 103. The temperature control unit 432 performs temperature control of the (container-type) data center 102 by air conditioning of the data center unit air conditioning device 330 according to the operation mode 103. The humidity control unit 433 performs humidity control of the (container-type) data center 102 by air conditioning of the data center unit air conditioning device 330 according to the operation mode 103.

The power storage control unit 440 controls the data center unit storage battery 340 according to the operation mode 103. The remaining charge amount management unit 441 controls a remaining charge amount of the data center unit storage battery 340 according to the operation mode 103.

The emergency power generation control unit 450 performs control related to the in-base emergency generator 350 according to the operation mode 103. The fuel reserve management unit 451 controls a reserve amount of the data center unit fuel 351 for the emergency generator according to the operation mode 103.

The workload deployment control unit 419 performs control related to the deployment of the workload to the (container-type) data center 102 according to an instruction of the workload deployment control information 212 (WL-deploy) or the workload redeployment control information 214 (WL-migration). In addition, the workload deployment control unit 419 may transmit information regarding the execution history or the execution state when the (container-type) data center 102 processes the workload to the system 101 as the workload execution history information 213 (WL-log) as appropriate.

### 4. FUNCTIONAL CONFIGURATION OF SYSTEM 101 (FIGS. 5 TO 14)

FIG. 5 illustrates a functional configuration 400 (or handled information) of the system 101 according to the embodiment of the present disclosure. Not all the functional configurations illustrated in FIG. 5 are essential. In addition, the existence of a functional configuration other than the functional configuration illustrated in FIG. 5 is not precluded.

Contents of processing performed by the system 101 illustrated in FIG. 5 and the like will be described in detail in Section “6. Processing Performed in Embodiment of Present Disclosure” described below. In Section “4. Functional Configuration of System 101”, an outline of the processing in the system 101 and an outline of information (table) handled by the system 101 will be described. Note that what has already been described with reference to FIG. 1 may be omitted below.

In FIG. 5, a solid rectangle with “unit” attached to the name indicates a functional unit. In FIG. 5, a dotted rectangle indicates the information (table) to be handled. In addition, the numbers with circles indicate that elements with the same numbers are connected to each other.

As illustrated in FIG. 5, the system 101 may include, as functional units, a workload actual record table creation unit 1600, a workload prediction unit 1700, the data center operation mode plan creation unit 1800, a data center operation mode control information transmission unit 510, a workload execution request reception unit 511, the workload deployment setting unit 1900, a workload deployment control information transmission unit 512, a workload execution history information reception unit 513, a workload redeployment setting unit 2000, and a workload redeployment control information transmission unit 514.

In a computer architecture 1500 as illustrated in FIG. 15 described below, in a case where each of the functional units is implemented in software by executing a program corresponding to each of the functional units, such a functional unit implemented in software does not need to be always implemented in the system 101. For example, when a function provided by a functional unit is necessary, the functional unit may be implemented in software in the system 101. Furthermore, in the system 101, any one of the functional units (alternatively, some functions of any one of the functional units) may be implemented more in hardware.

As illustrated in FIG. 5, the system 101 may include, as tables for managing the information handled by any one of the functional units, a data center list table 600, a data center operation mode list table 700, a workload actual record table 800, a workload prediction table 900, a data center operation mode plan table 1000, a workload execution request buffer table 1100, a workload deployment setting table 1200, a workload execution history table 1300, and a workload redeployment setting table 1400.

Each of the tables described above may be recorded, for example, as a part of a data group 1532 in a non-volatile recording medium (recording device) 1503 in the computer architecture 1500 of FIG. 15 described below. Alternatively, each of the tables described above may be stored as a part of various buffers 1523, for example, in a storage device (memory) 1502 in the computer architecture 1500. Alternatively, each of the tables described above may be held in a recording medium, a storage medium, a device, a system, a server, or the like that can be accessed by or communicate with the computer architecture 1500.

FIG. 5 illustrates a case where the information handled by any one of the functional units is managed by the table, but a method other than the table may be used as an aspect of information management.

### 4-1. Outline of Functional Unit

Hereinafter, an outline of processing in each of the functional units illustrated in FIG. 5 will be described. Each table is also mentioned in the description of the outline of the processing in each of the functional units, but an outline of each table will be described in “4-2. Outline of Table for Managing Handled Information” described below.

### 4-1-1. Outline of Functional Unit Related to Creation of Information Regarding Actual Record of Workload

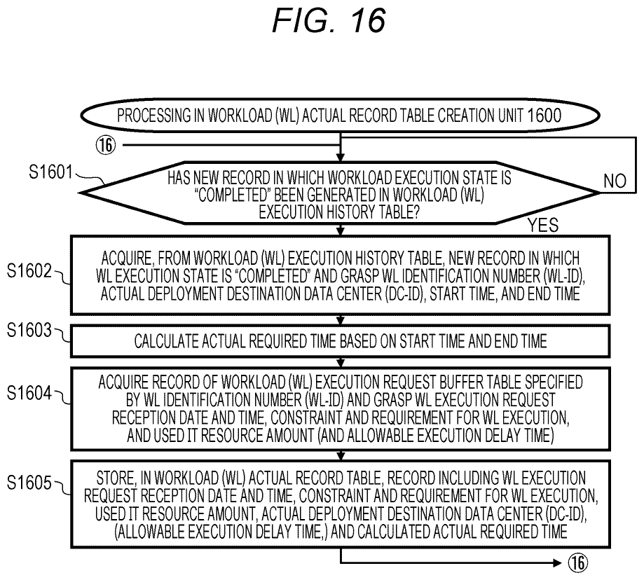

The workload actual record table creation unit 1600 creates a record including information regarding an actual record of reception of the workload execution request 211. More specifically, the workload actual record table creation unit 1600 may create the record including the information regarding the actual record of the reception of the workload execution request 211 based on information regarding the workload execution request 211 read from the workload execution request buffer table 1100 and information regarding the execution history of the workload associated with the workload execution request 211 read from the workload execution history table 1300. The workload actual record table creation unit 1600 stores the created record in the workload actual record table 800. Details of the processing in the workload actual record table creation unit 1600 are described below with reference to FIG. 16.

### 4-1-2. Outline of Functional Unit Related to Creation of Data Center Operation Mode Plan

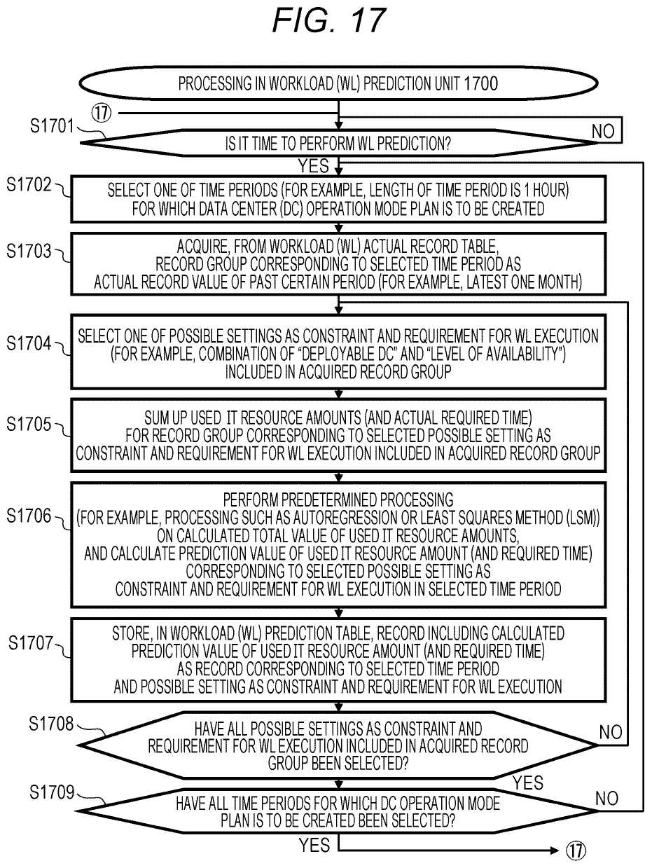

The workload prediction unit 1700 creates the prediction 109 regarding the workload. More specifically, the workload prediction unit 1700 may create the prediction 109 regarding the workload based on the information regarding the actual record of the reception of the workload execution request 211 read from the workload actual record table 800. The workload prediction unit 1700 stores information indicating the created prediction 109 regarding the workload in the workload prediction table 900. Details of the processing in the workload prediction unit 1700 are described below with reference to FIG. 17.

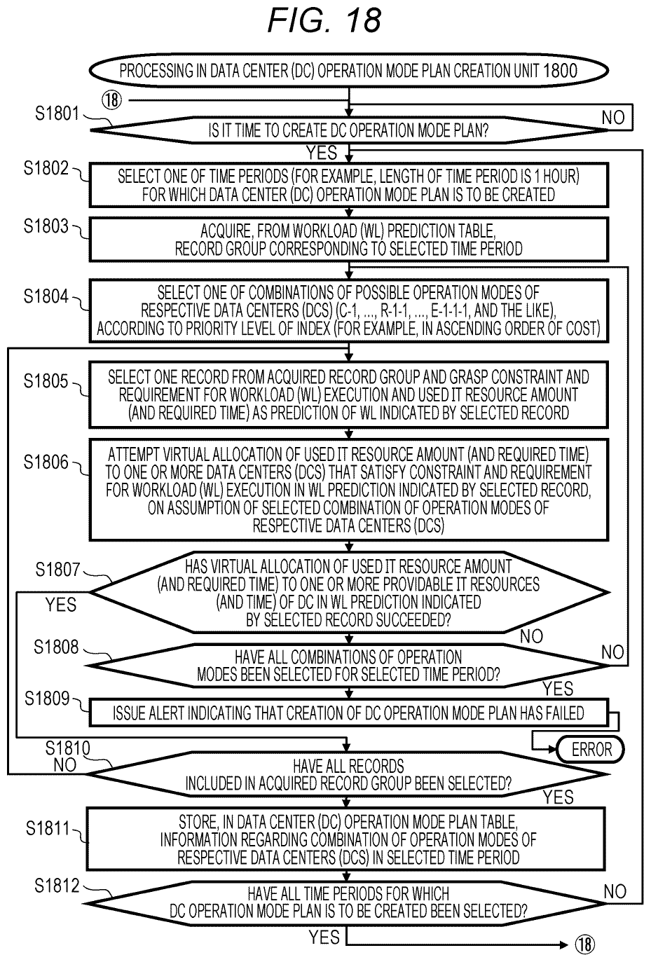

The data center operation mode plan creation unit 1800 creates the data center operation mode plan 110. More specifically, the data center operation mode plan creation unit 1800 may create the data center operation mode plan 110 based on information regarding the content (for example, the type, performance, or amount) of the information processing resource held by each data center 102 read from the data center list table 600, information regarding the achievable level of the availability for each combination of the data center 102 and the operation mode 103 read from the data center operation mode list table 700, information regarding the content (for example, the type, performance, or amount) of the information processing resource held by the data center providable to the workload, information regarding values of one or more types of indices, and the information indicating the prediction 109 regarding the workload read from the workload prediction table 900. The data center operation mode plan creation unit 1800 stores information indicating the created data center operation mode plan 110 in the data center operation mode plan table 1000. Details of the processing in the data center operation mode plan creation unit 1800 are described below with reference to FIG. 18.

The data center operation mode control information transmission unit 510 may generate the data center operation mode control information 210 (DC-mode). More specifically, the data center operation mode control information transmission unit 510 may generate the data center operation mode control information 210 (DC-mode) indicating the operation mode 103 of each of the data centers 102 in a predetermined time zone based on the information indicating the data center operation mode plan 110 read from the data center operation mode plan table 1000. The data center operation mode control information transmission unit 510 may transmit the created data center operation mode control information 210 (DC-mode) to the data center 102 as the destination. Details of the processing in the data center operation mode control information transmission unit 510 are described below.

### 4-1-3. Outline of Functional Unit Related to Deployment Setting for Deployment of Workload to Data Center

The workload execution request reception unit 511 may receive the workload execution request 211 from the execution request device 105 serving as the issuing source of the workload execution request 211. Furthermore, the workload execution request reception unit 511 may generate a record including the condition when the workload associated with the received workload execution request 211 is processed. In addition, the workload execution request reception unit 511 may store the generated record in the workload execution request buffer table 1100. Details of the processing in the workload execution request reception unit 511 are described below.

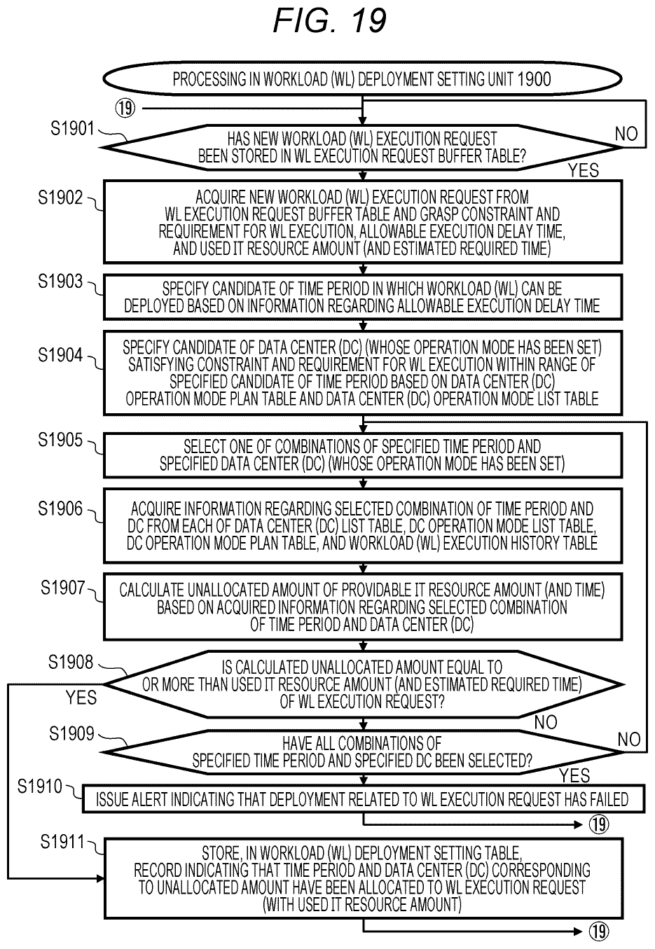

The workload deployment setting unit 1900 determines the data center 102 to which the workload associated with the workload execution request 211 is to be deployed. More specifically, the workload deployment setting unit 1900 may determine the data center 102 to which the workload associated with the workload execution request 211 is to be deployed based on the information regarding the content (for example, the type, performance, or amount) of the information processing resource held by each data center 102 read from the data center list table 600, the information regarding the level of the achievable availability for each combination of the data center 102 and the operation mode 103 read from the data center operation mode list table 700, the information regarding the content (for example, the type, performance, or amount) of the information processing resource held by the data center 102 providable to the workload, information regarding the setting of the operation mode 103 of each data center 102 read from the data center operation mode plan table 1000, information regarding the execution history or the execution state of another workload deployed to each data center read from the workload execution history table 1300, and the record associated with the workload execution request 211 read from the workload execution request buffer table 1100. The workload deployment setting unit 1900 may store a record including information for identifying the determined data center 102 in the workload deployment setting table 1200. Details of the processing in the workload deployment setting unit 1900 are described below with reference to FIG. 19.

The workload deployment control information transmission unit 512 may generate the workload deployment control information 212 (WL-deploy). More specifically, the workload deployment control information transmission unit 512 may generate the workload deployment control information 212 (WL-deploy) indicating that the workload indicated by the record is to be deployed to the data center 102 indicated by the record based on the record read from the workload deployment setting table 1200 and including the information for identifying the data center 102 to which the workload is to be deployed. The workload deployment control information transmission unit 512 may transmit the generated workload deployment control information 212 (WL-deploy) to the data center 102 as the destination. In addition, the workload deployment control information transmission unit 512 may store a record indicating that the workload has been deployed to the data center 102 in the workload execution history table 1300. Details of the processing in the workload deployment control information transmission unit 512 are described below.

### 4-1-4. Outline of Functional Unit Related to Reception of Execution History Information of Workload

The workload execution history information reception unit 513 may receive, from the data center 102, the workload execution history information 213 (WL-log) which is information regarding the execution history or the execution state related to the workload deployed to the data center 102. In addition, the workload execution history information reception unit 513 may update a content of the record in the workload execution history table 1300 based on the received workload execution history information 213 (WL-log). Details of the processing in the workload execution history information reception unit 513 are described below.

### 4-1-5. Outline of Functional Unit Related to Redeployment Setting for Redeployment of Workload to Data Center

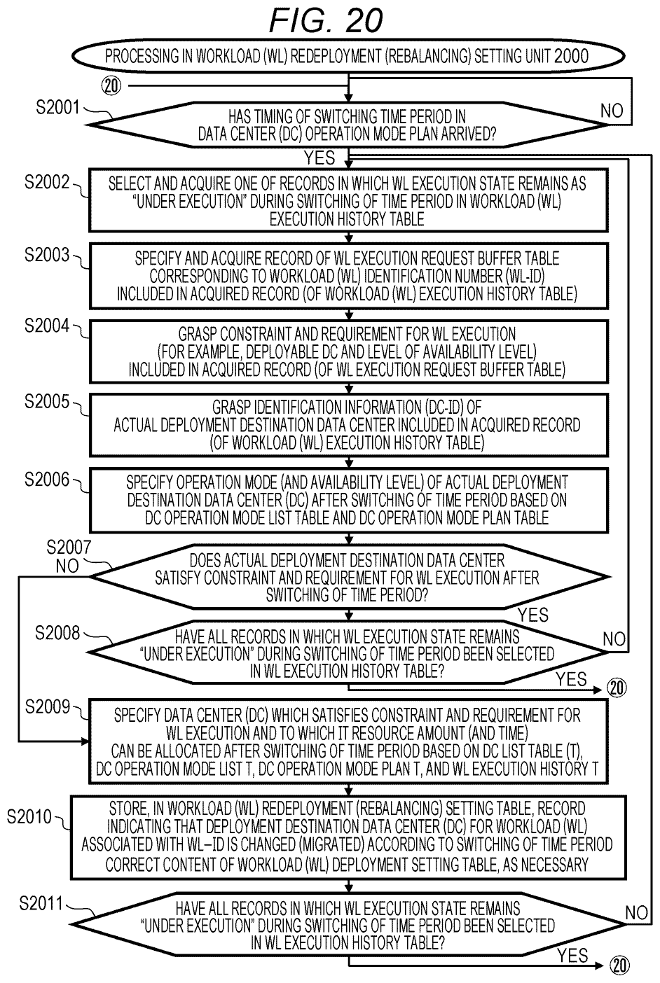

When the operation mode 103 of any one of the data centers 102 is changed based on the data center operation mode plan 110, the workload redeployment setting unit 2000 determines to redeploy (rebalance or migrate) the workload for which the changed operation mode 103 does not satisfy the condition when the workload is processed to another data center 102 that satisfies the condition. More specifically, the workload redeployment setting unit 2000 may determine to redeploy (rebalance or migrate), to another data center 102 that satisfies the condition when the workload is processed, the workload for which the changed operation mode 103 does not satisfy the condition due to the change of the operation mode 103 of any one of the data centers 102 based on each of the information regarding the content (for example, the type, performance, or amount) of the information processing resource held by each data center 102 read from the data center list table 600, the information regarding the level of the achievable availability for each combination of the data center 102 and the operation mode 103 read from the data center operation mode list table 700, the information regarding the content (for example, the type, performance, or amount) of the information processing resource held by the data center 102 providable to the workload, the information regarding the setting of the operation mode 103 of each data center 102 read from the data center operation mode plan table 1000, the information regarding the execution history or the execution state of another workload deployed to each data center 102 read from the workload execution history table 1300, and the record associated with each workload execution request 211 read from the workload execution request buffer table 1100. The workload redeployment setting unit 2000 may store a record including information for identifying the determined data center 102 as the redeployment destination (migration destination) in the workload redeployment setting table 1400. Furthermore, the workload redeployment setting unit 2000 may update a content of the record in the workload deployment setting table 1200. Details of the processing in the workload redeployment setting unit 2000 are described below with reference to FIG. 20.

The workload redeployment control information transmission unit 514 may generate the workload redeployment control information 214 (WL-migration). More specifically, the workload redeployment control information transmission unit 514 may generate the workload redeployment control information 214 (WL-migration) indicating that the workload indicated by the record is to be deployed to the data center 102 as the redeployment destination indicated by the record based on the record read from the workload redeployment setting table 1400 and including the information for identifying the data center 102 as the redeployment destination (migration destination) to which the workload is to be redeployed (rebalanced or migrated). The workload redeployment control information transmission unit 514 may transmit the generated workload redeployment control information 214 (WL-migration) to the data center 102 as the deployment destination (migration source) before the redeployment and the data center 102 as the redeployment destination (migration destination). Furthermore, the workload redeployment control information transmission unit 514 may update a content of the record in the workload execution history table 1300 so as to indicate that the data center 102 as the deployment destination of the workload has been changed. Details of the processing in the workload redeployment control information transmission unit 514 are described below.

### 4-2. Outline of Table for Managing Handled Information

Hereinafter, an outline of each table for managing the information handled by each of the functional units illustrated in FIG. 5 will be described.

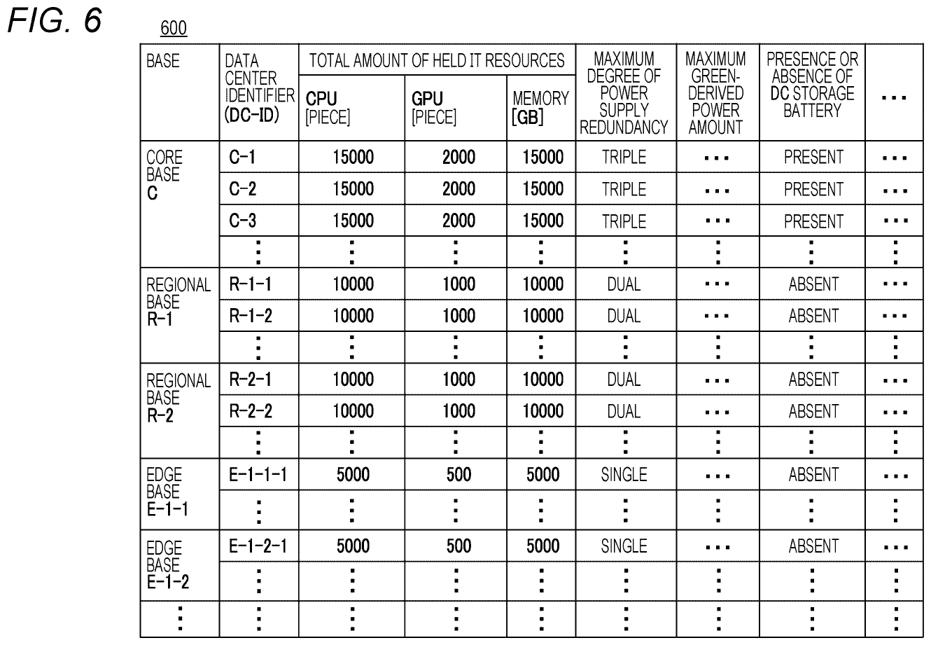

### 4-2-1. Outline of Data Center List Table 600 (FIG. 6)

FIG. 6 illustrates the data center list table 600. The data center list table 600 shows a list of the (container-type) data centers 102 existing in each of the bases 202. In addition, the data center list table 600 may include, for each of the existing (container-type) data centers 102, information indicating the information processing resource (for example, the type, performance, or amount of the information processing resource (IT resource)) held by the data center 102 and a content (for example, the type and performance of the facility) of the facility related to the data center. (Hereinafter, the information processing resource may be referred to as “IT resource”.)

In the example of FIG. 6, the data center list table 600 includes, for each record, pieces of information such as identification information of the base 202, identification information (data center identifier (DC-ID)) of the data center 102, the total amounts of held IT resources (the number of central processing units (CPUs), the number of graphics processing units (GPUS), a capacity of the memory), a maximum value of the degree of power supply redundancy, a maximum value of a power amount (green-derived power amount) from the power generation source with a relatively low carbon emission, and the presence or absence of the data center unit storage battery 340.

For example, the first record of the data center list table 600 in the example of FIG. 6 indicates that the data center 102 whose data center identifier (DC-ID) is “C−1” exists in the “core base 202-C (core base C)”, that the data center 102 includes 15000 central processing units (CPUs), 2000 graphics processing units (GPUs), and the memory having a capacity of 15000 gigabytes (GB), that the maximum value of the degree of power supply redundancy of the data center 102 is 3, and that the data center unit storage battery 340 exists for the data center.

### 4-2-2. Outline of Data Center Operation Mode List Table 700 (FIG. 7)

FIG. 7 illustrates the data center operation mode list table 700.

The data center operation mode list table 700 shows a list of the operation modes 103 that can be set for each of the data centers 102 whose existence is shown in the data center list table 600. In addition, the data center operation mode list table 700 may include, for each combination of the data center 102 and the operation mode 103, the information regarding the level of the availability achievable when performing the processing of the workload, and information regarding a content (for example, the type, ability, or amount) of the information processing resource (IT resource) providable for the processing of the workload (in the content (for example, the type, performance, or amount) of the information processing resource (IT resource) held by the data center 102). Furthermore, the data center operation mode list table 700 may include, for each combination of the data center 102 and the operation mode 103, information regarding a content of control for the facility related to the data center 102 to achieve the achievable level of the availability described above. In addition, the data center operation mode list table 700 may include, for each combination of the data center 102 and the operation mode 103, one or more indices serving as a determination material when determining whether or not to select the operation mode 103.

In the example of FIG. 7, the data center operation mode list table 700 includes, for each record, pieces of information such as the identification information (data center identifier (DC-ID)) of the data center 102, identification information (operation mode number) of the operation mode 103, a content of control for the IT resource held by the data center 102 (for example, a content of control of the proportion of the servers to be powered on among the servers 302 held by the data center 102), a content of the IT resources providable for the processing of the workload (for example, a proportion of the performance and amount of the information processing resource providable for the processing of the workload in the operation mode 103 to maximum values of the performance and amount of the information processing resource achievable by all the IT resources held by the data center 102), the content of the control of the facility related to the data center 102, the level of the availability achievable when performing the processing of the workload in the operation mode 103, and an index group associated with the operation mode 103. Here, the content of the control of the facility related to the data center 102 may specifically include a content of on/off control of the data center unit air conditioning device 330, a content of temperature adjustment of the data center unit air conditioning device 330, a content of humidity adjustment of the data center unit air conditioning device 330, a content of the control of the remaining charge amount of the data center unit storage battery 340, and a content of control of a reserve of the data center unit fuel 351 for the emergency generator. In addition, the index group associated with the operation mode 103 may specifically include a unit price (a portion of the cost here may be electricity charges) of a cost in the operation mode 103 (with the highest priority level (Priority Level 1) when performing the setting of the operation mode 103), a ratio of the power amount (green-derived power amount) from the power generation source with a relatively low carbon emission to the power consumption in the operation mode 103 (with the second highest priority (Priority Level 2) when performing the setting of the operation mode 103), and the index related to the adjustment compensation (compensation that can be received by a person operating the base 202 and the data center 102 from a supply-demand balancing market by reducing the power amount received by the base 202 and the data center 102 from the power transmission and distribution system 370) in the operation mode 103 (with the third highest priority (Priority Level 3) when performing the setting of the operation mode 103).

Since the operation mode 103 is associated with each piece of control information described above in advance, it is possible to implement detailed handling in control of the facility corresponding to the operation mode 103 and the like while performing simple handling of setting the operation mode 103 in the data center 102.

For example, in conjunction with the setting of the operation mode 103 in the data center 102, the level of the availability achieved in the data center 102 and the content (for example, the type, performance, or amount) of the providable information processing resource (IT resource) can be controlled. Here, since the level of the availability achieved in the data center 102 and the content (for example, the type, performance, or amount) of the providable information processing resource (IT resource) can be easily compared with the “condition” when processing the workload, it can be expected that it is easy to determine whether or not it is possible to allocate (deploy) the workload with a predetermined “condition” to the data center 102 in which the operation mode 103 is set.

In addition, for example, in conjunction with the setting of the operation mode 103 in the data center 102, it is possible to set control related to the facility such as the air conditioning device, the storage battery, or the emergency generator in order to achieve a predetermined level of the availability in the data center 102. That is, it is possible to quickly implement specific control related to the facility for achieving the predetermined level of the availability.

Since the operation mode 103 is associated with each index described above in advance and the priority levels of the indices are set in advance, it is easy to specify a combination to be preferentially adopted in a set of combinations that can process the workload group included in the prediction 109 regarding the workload among the combinations of the values (operation mode numbers) of the operation modes 103 for each data center 102 when creating the data center operation mode plan 110.

In the example of FIG. 7, a record in the data center operation mode list table 700 is common for the data centers 102 (a data center group existing in the core base 202-C) whose identification information (data center identifier (DC-ID)) is “C−1”, “C−2”, and “C−3”. Similarly, a record in the data center operation mode list table 700 is common for the data centers 102 (a data center group existing in the regional base 202-R-1 or the regional base 202-R-2) whose identification information (data center identifier (DC-ID)) is “R-1-1”, “R-1-2”, “R-2-1”, and “R-2-2”. Similarly, a record of the data center operation mode list table 700 is common for the data centers 102 (a data center group existing in the edge (zone) base 202-E-1-1 or the edge (zone) base 202-E-1-2) whose identification information (data center identifier (DC-ID)) is “E-1-1-1” and “E-1-2-1”.

However, the record of the data center operation mode list table 700 may exist for each of the data centers 102 existing in the same base 202. In addition, for example, the record of the data center operation mode list table 700 may be provided in common to the data center groups existing in the core base 202-C (core base C) and the regional base 202-R-1.

For example, the second record from the beginning of the data center operation mode list table 700 in the example of FIG. 7 indicate that the operation mode “1” exists in the data center 102 whose data center identifier (DC-ID) is any one of “C-1”, “C-2”, and “C-3”. Further, the record indicates that, when the operation mode “1” is set in the data center 102 whose data center identifier (DC-ID) is any one of “C-1”, “C-2” or “C-3”, the proportion of servers to be powered on among the servers 302 held by the data center 102 is controlled to 30% (accordingly, the proportion of the performance and amount of the information processing resource providable for the processing of the workload in the operation mode 103 to the maximum values of the performance and amount of the information processing resource that can be implemented by all the IT resources held by the data center 102 is also 30%). Further, the record indicates that, when the operation mode “1” is set in the data center 102 whose data center identifier (DC-ID) is any one of “C-1”, “C-2”, and “C-3”, the data center unit air conditioning device 330 is powered on, the temperature is controlled to be in a range of 18 degrees Celsius to 27 degrees Celsius, the humidity is controlled to be in a range of 40% to 60%, the remaining charge amount of the data center unit storage battery 340 is controlled to be 60% or more, and the reserve of the data center unit fuel 351 for the emergency generator is controlled to be 60% or more, and the level of the availability achievable when performing the processing of the workload is “2” based on the control of these facilities. In addition, the record indicates that, when the operation mode “1” is set in the data center 102 whose data center identifier (DC-ID) is any one of “C-1”, “C-2”, and “C-3”, in the index group associated with the operation mode 103, the unit price of the cost in the operation mode 103 is “0.05 million yen/month”, the ratio of the power amount (green-derived power amount) from the power generation source with a relatively low carbon emission to the power consumption in the operation mode 103 is “0.7 (70%)”, and the index related to the adjustment compensation in the operation mode 103 is “0.1”.

The example of FIG. 7 shows that as the amount of the providable information processing resource (IT resource) increases, the ratio of the power amount (green-derived power amount) from the power generation source with a relatively low carbon emission to the power consumption decreases. This example shows a case where there is an upper limit to the green-derived power amount that can be used by one data center 102. However, there are various methods for carbon neutralization. Examples of the method include purchase of a non-fossil value certificate, purchase of green-derived power from a power company, and procurement of renewable energy under a power purchase agreement (PPA). Therefore, in another example, a tendency of the ratio of the green-derived power amount for the operation mode may be different from that in FIG. 7.

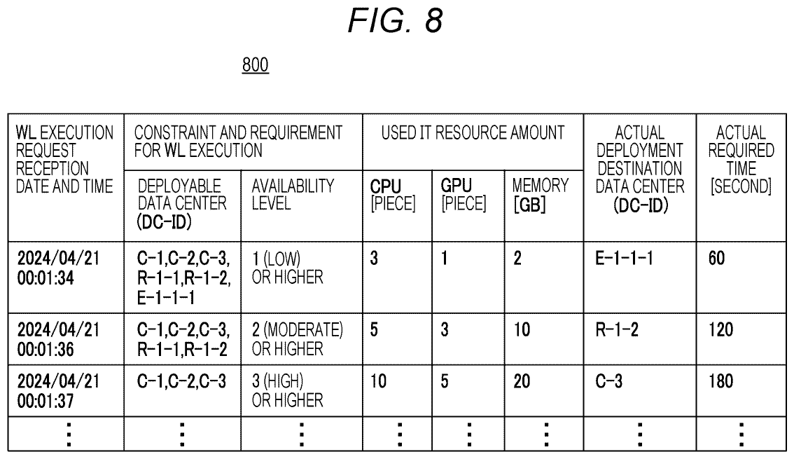

### 4-2-3. Outline of Workload Actual Record Table 800 (FIG. 8)

FIG. 8 illustrates the workload actual record table 800.

The workload actual record table 800 shows information regarding an actual record of the workload execution request 211 (the actual record of the reception of the workload execution request 211 and an actual record of the processing of the workload) received by the system 101 from the execution request device 105 serving as the issuing source of the workload execution request 211. The workload actual record table 800 may include a record for each workload execution request 211 received by the system 101.

In the example of FIG. 8, the workload actual record table 800 includes, for each record, pieces of information such as a date and time when the system 101 has received the workload execution request 211, a constraint and a requirement imposed on the data center 102 serving as a processing subject when processing the workload associated with the workload execution request 211, a content of the IT resources (mainly the amounts of the IT resources in the example of FIG. 8) used when processing the workload, the identification information (data center identifier (DC-ID)) of the data center 102 (actual deployment destination data center) to which the workload has been actually deployed, and a processing time (actual required time) required when the workload has been actually processed. (If the identification information of the actual deployment destination data center among the pieces of information described above is not used in the processing performed by the workload prediction unit 1700, the identification information of the actual deployment destination data center does not have to be included in the record of the workload actual record table 800 illustrated in FIG. 8.)

Here, the constraint and the requirement imposed on the data center 102 serving as the processing subject when processing the workload may specifically include information (data center identifier (DC-ID)) for identifying the data center 102 to which the workload can be deployed when another condition (a constraint, a requirement, the amounts of available IT resources that can be allocated, or the like) is satisfied (hereinafter, simply referred to as “deployable data center”), and a level of the availability required when processing the workload. In addition, the content of the IT resources used when processing the workload may specifically include the number of central processing units (CPUs), the number of graphics processing units (GPUs), and the capacity of the memory used when processing the workload.

A combination of the constraint and the requirement imposed on the data center 102 serving as the processing subject when processing the workload associated with the workload execution request 211 and the content of the IT resources used when processing the workload may indicate the “condition” when the workload is processed.

For example, the first record of the workload actual record table 800 in the example of FIG. 8 indicates that the system 101 has received the workload execution request 211 at 00:01:34 on Apr. 21, 2024. Further, the record indicates that the data center identifier (DC-ID) of the “deployable data center” is any one of “C-1”, “C-2”, “C-3”, “R-1-1”, “R-1-2”, and “E-1-1-1”, the level of the availability required when processing the workload is “1 or higher (such as 1, 2, or 3)”, the number of central processing units (CPUs) used when processing the workload is “3”, the number of graphics processing units (GPUs) is “1”, and the capacity of the memory is “2 gigabytes (GB)”, for the condition when the workload associated with the workload execution request 211 is processed. Further, the record indicates that the data center identifier (DC-ID) of the data center 102 (actual deployment destination data center) to which the workload associated with the workload execution request 211 has been actually deployed is “E-1-1-1”, and the time (actual required time) required when the workload has been actually processed is “60 seconds”.

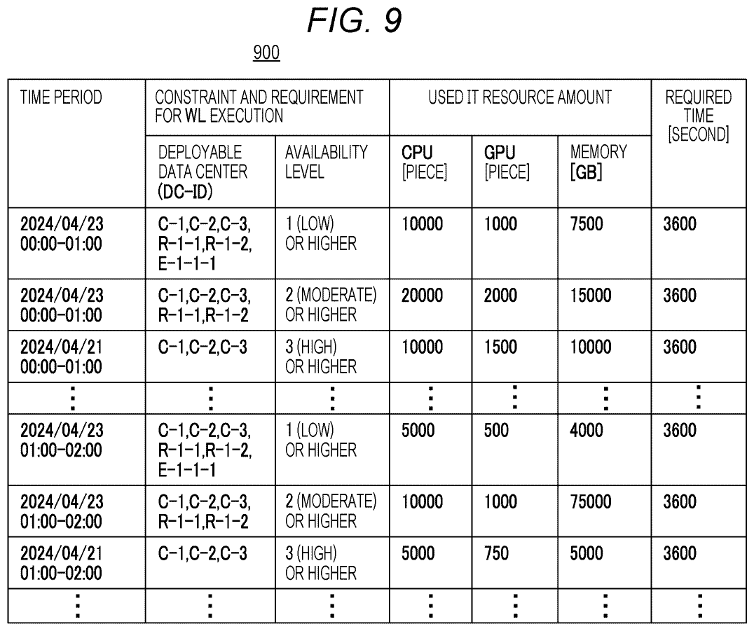

### 4-2-4. Outline of Workload Prediction Table 900 (FIG. 9)

FIG. 9 illustrates the workload prediction table 900.

The workload prediction table 900 shows a content of the prediction 109 regarding the workload. The workload prediction table 900 may include, for example, information indicating a content of the workload to be processed in a period having a predetermined length (for example, 1 day (24 hours) or 7 days (168 hours)). Here, the information indicating the content of the workload to be processed may include, for example, pieces of information such as the condition (the constraint and the requirement imposed on the data center 102 serving as the processing subject when processing the workload) when processing the workload, the content (for example, the type, performance, or amount) of the IT resource used when processing the workload, and a temporal amount of the workload. Further, the prediction 109 regarding the workload shown in the workload prediction table 900 may be a prediction for each of time zones having a predetermined length (for example, 1 hour or 4 hours).

In the example of FIG. 9, a record of the workload prediction table 900 exists for each of combinations of a predicted target time zone (a time zone having a length of 1 hour in the example of FIG. 9) and the constraint and the requirement imposed on the data center 102 serving as the processing subject when processing the workload. The record may include information regarding the content (for example, the type, performance, or amount) of the IT resource and the temporal amount of the workload for the combination of the time zone and the constraint and the requirement. That is, the workload prediction table 900 may include a plurality of records for one time zone.

More specifically, in the example of FIG. 9, the workload prediction table 900 includes, for each record, information such as the type and the number of IT resources (the number of central processing units (CPUs), the number of graphics processing units (GPUS), and the capacity of the memory) used when processing the workload and the time (required time) predicted to be required to process the workload using these types and numbers of IT resources, for the combination of the predicted target time zone (a time zone having a length of 1 hour in the example of FIG. 9), the data center identifier (DC-ID) of the “deployable data center”, and the level of the availability required when processing the workload. (If the required time in each record of the workload prediction table 900 is always set to be constant (for example, set to 3600 seconds), the record of the workload prediction table 900 does not have to explicitly include the information regarding the required time)

For example, the first record of the workload prediction table 900 in the example of FIG. 9 indicates that a workload group in which the data center identifier of the “deployable data center” is any one of “C-1”, “C-2”, “C-3”, “R-1-1”, “R-1-2”, and “E-1-1-1” and the level of the availability required when processing the workload is “1 or higher (such as 1, 2, or 3)” in a time zone from 00:00 to 01:00 on Apr. 23, 2024 has a content to be processed by the information processing resources including 10000 central processing units (CPUs), 1000 graphics processing units (GPUs), and the memory having a capacity of 7500 gigabytes (GB) as a whole for 3600 seconds.

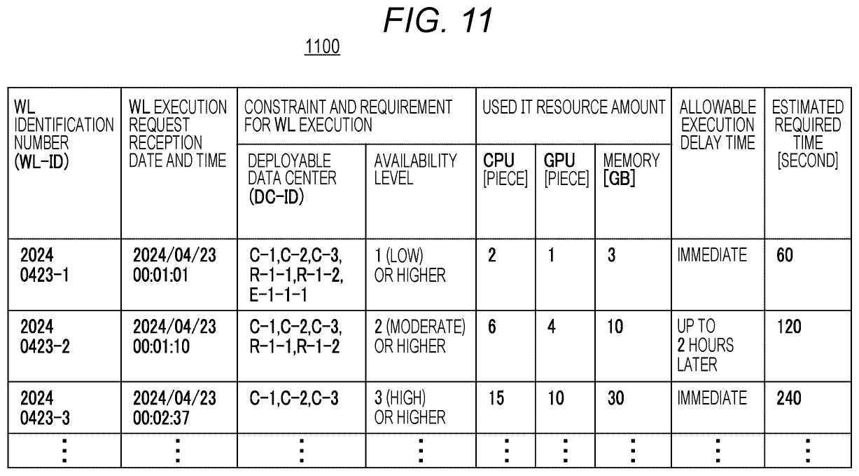

As illustrated in relation to FIG. 11 described below, for all of the workload execution requests 211, the processing of the workload associated with the workload execution request 211 does not necessarily need to be immediately performed in any one of the data centers 102. That is, in the workload execution request 211, a length of a time (allowable execution delay time) by which the execution of the processing of the workload associated with the workload execution request 211 is allowed to be delayed may be set.

In this regard, the workload prediction table 900 of FIG. 9 may include a record for each of combinations of the predicted target time zone (a time zone having a length of 1 hour in the example of FIG. 9), a length of the allowable execution delay time, and the constraint and the requirement imposed on the data center 102 serving as the processing subject when processing the workload.

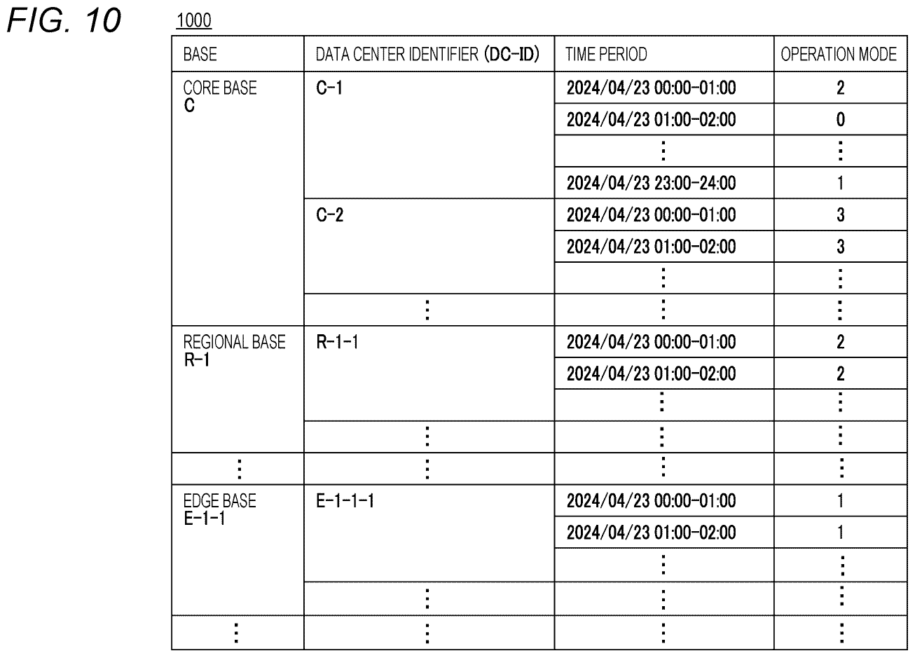

### 4-2-5. Outline of Data Center Operation Mode Plan Table 1000 (FIG. 10)

FIG. 10 illustrates the data center operation mode plan table 1000.

The data center operation mode plan table 1000 shows the data center operation mode plan 110. The data center operation mode plan table 1000 may show, for example, the operation mode 103 set in each of the data centers 102 in a period having a predetermined length (for example, 1 day (24 hours) or 7 days (168 hours)). In addition, the data center operation mode plan 110 shown in the data center operation mode plan table 1000 may include the setting of the operation mode 103 for each time zone having a predetermined length (for example, 1 hour or 4 hours).

In the example of FIG. 10, the data center operation mode plan table 1000 includes, for each record, pieces of information such as the identification information of the base 202, the identification information (data center identifier (DC-ID)) of the data center 102, the time zone (the length of the time zone is 1 hour in the example of FIG. 10), and the identification information (operation mode number) of the operation mode 103.

For example, the first record of the data center operation mode plan table 1000 in the example of FIG. 10 indicates that “2” is planned to be set as the operation mode in a time zone from 00:00 to 01:00 on Apr. 23, 2024 for the data center 102 whose data center identifier (DC-ID) is “C-1” in the “core base 202-C (core base C)”.

### 4-2-6. Outline of Workload Execution Request Buffer Table 1100 (FIG. 11)

FIG. 11 illustrates the workload execution request buffer table 1100.

The workload execution request buffer table 1100 buffers the information regarding the workload execution request 211 received by the system 101. The information regarding the workload execution request 211 held in the workload execution request buffer table 1100 may include information determined by the workload execution request reception unit 511 for the workload associated with the workload execution request 211 in addition to information explicitly held in the workload execution request 211 itself. The workload execution request buffer table 1100 may include a record for each workload execution request 211 received by the system 101. (However, after the processing of the workload associated with the workload execution request 211 corresponding to the record is completed in any one of the data centers 102 and the information regarding the workload execution request 211 is reflected in the workload actual record table 800, the record can be deleted from the workload execution request buffer table 1100.)

In the example of FIG. 11, the workload execution request buffer table 1100 includes, for each record, pieces of information such as identification information (workload identification number (WL-ID)) assigned to the workload, the date and time when the system 101 has received the workload execution request 211, the constraint and the requirement imposed on the data center 102 serving as the processing subject when processing the workload associated with the workload execution request 211, a content of the IT resources (mainly the amounts of the IT resources in the example of FIG. 11) used when processing the workload, the length of the time (allowable execution delay time) by which the execution of the processing of the workload is allowed to be delayed, and a length of a time (estimated required time) assumed to be required when the processing of the workload is performed in any one of the data centers. Here, the constraint and the requirement imposed on the data center 102 serving as the processing subject when processing the workload may specifically include the information (data center identifier (DC-ID)) for identifying the data center 102 (“deployable data center”) to which the workload can be deployed when another condition (a constraint, a requirement, the amounts of available IT resources that can be allocated, or the like) is satisfied, and information regarding the level of the availability required when processing the workload. In addition, the content of the IT resources used when processing the workload may specifically include the number of central processing units (CPUs), the number of graphics processing units (GPUS), and the capacity of the memory used when processing the workload.

Further, a combination of the constraint and the requirement imposed on the data center 102 serving as the processing subject when processing the workload associated with the workload execution request 211 and the content of the IT resources used when processing the workload may indicate the “condition” when the workload is processed.

By configuring the “condition” when the workload is processed as described above, each of a geographical condition of the data center 102 serving as the processing subject (or a requirement for a response speed of a processing result), an availability condition, and a processing speed or processing amount condition when the workload is processed can be included in consideration targets in the allocation (deployment) of the workload to the data center 102.

In addition, by making it possible to set the allowable execution delay time as described above, it is possible to implement scheduling of the processing of the workload according to a property of the workload. For example, in the case of a type of workload having a strong property of batch processing, the start of the processing of the workload may be delayed to some extent in many cases. By using the property of the workload as described above, it can be expected that there is room for the scheduling of the processing in a group of the data centers 102.

For example, the first record of the workload execution request buffer table 1100 in the example of FIG. 11 indicates that the system 101 has received the workload execution request 211 at 00:01:01 on Apr. 23, 2024. Further, the record indicates that “20240423-1” is assigned as the WL identification number (WL-ID) to (the workload associated with) the received workload execution request 211. Furthermore, the record indicates that the data center identifier (DC-ID) of the “deployable data center” is any one of “C-1”, “C-2”, “C-3”, “R-1-1”, “R-1-2”, and “E-1-1-1”, the level of the availability required when processing the workload is “1 or higher (such as 1, 2, or 3)”, the number of central processing units (CPUs) used when processing the workload is “2”, the number of graphics processing units (GPUs) is “1”, and the capacity of the memory is “3 gigabytes (GB)”, for the condition when the workload associated with the workload execution request 211 is processed. In addition, the record indicates that “immediate” is set as the allowable execution delay time (that is, the delay of the execution is not allowed). Finally, the record indicates that the estimated required time is “60 seconds” in a case where the workload associated with the workload execution request is processed by the information processing resources in which the number of central processing units (CPUs) is “2”, the number of graphics processing units (GPUs) is “1”, and the capacity of the memory is “3 gigabytes (GB)”.

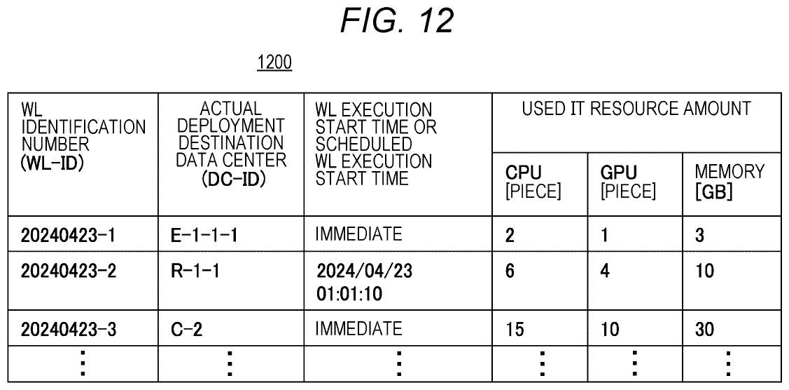

### 4-2-7. Outline of Workload Deployment Setting Table 1200 (FIG. 12)

FIG. 12 illustrates the workload deployment setting table 1200.

The workload deployment setting table 1200 shows the deployment setting 112 for deployment of the workload to the data center. The workload deployment setting table 1200 may include, for example, a record for each workload execution request 211 received by the system 101. (However, after the processing of the workload associated with the workload execution request 211 corresponding to the record is completed in any one of the data centers 102, the record can be deleted from the workload deployment setting table 1200.)

In the example of FIG. 12, the workload deployment setting table 1200 includes, for each record, pieces of information such as the identification information (workload identification number (WL-ID)) assigned to the workload, the identification information (data center identifier (DC-ID)) of the data center 102 (actual deployment destination data center) to which the workload is actually deployed, a time at which the processing of the workload starts (has started) or a time at which the processing is scheduled to start (WL execution start time or scheduled WL execution start time), and a content of the IT resources (mainly the amounts of the IT resources in the example of FIG. 12) allocated by the data center 102 as the deployment destination for the processing of the workload. Here, the information regarding the content of the IT resources (mainly the amounts of the IT resources in the example of FIG. 12) allocated by the data center 102 as the deployment destination for the processing of the workload may include information regarding the number of central processing units (CPUs), the number of graphics processing units (GPUs), and the capacity of the memory.

For example, the first record of the workload deployment setting table 1200 in the example of FIG. 12 indicates that, for the workload to which “20240423-1” is assigned as the WL identification number (WL-ID), the identification information (data center identifier (DC-ID)) of the data center 102 as the actual deployment destination of the workload is “E-1-1-1”, the execution start time of the workload is set to “immediate” (the delay of the execution is not allowed), and the IT resources allocated for the processing of the workload include “2” central processing units (CPUs), “1” graphics processing unit (GPU), and the memory having a capacity of “3 gigabytes (GB)”.

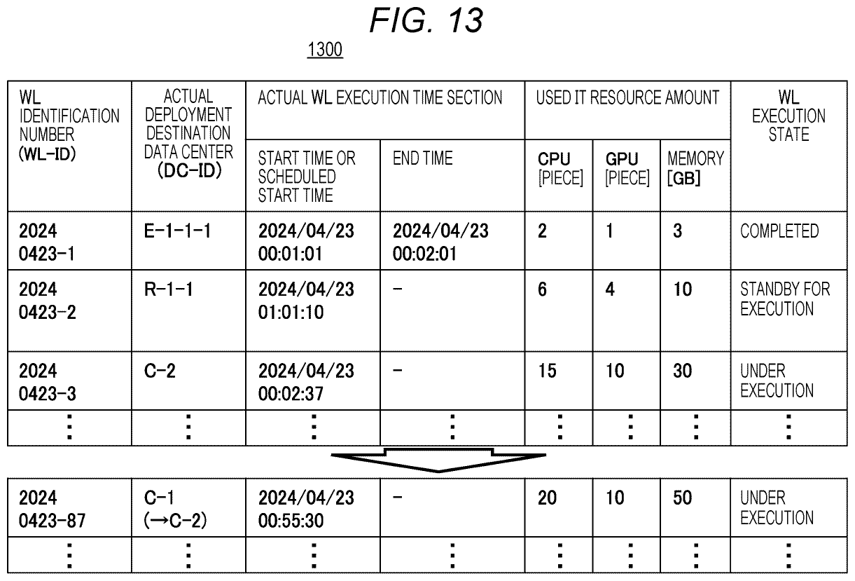

### 4-2-8. Outline of Workload Execution History Table 1300 (FIG. 13)

FIG. 13 illustrates the workload execution history table 1300.

The workload execution history table 1300 shows the information regarding the execution history and the execution state of each workload associated with the workload execution request 211 received by the system 101. The workload execution history table 1300 may include, for example, a record for each workload execution request 211 received by the system 101. (However, after the processing of the workload associated with the workload execution request 211 corresponding to the record is completed in any one of the data centers 102 and the information regarding the workload execution request 211 is reflected in the workload actual record table 800, the record can be deleted from the workload execution history table 1300.)

In the example of FIG. 13, the workload execution history table 1300 includes, for each record, pieces of information such as the identification information (workload identification number (WL-ID)) assigned to the workload, the identification information (data center identifier (DC-ID)) of the data center 102 (actual deployment destination data center) to which the workload has been actually deployed, information regarding a time section during which the workload is executed (has been executed) (actual WL execution time section), a content of the IT resources (mainly the amounts of the IT resources in the example of FIG. 13) allocated by the data center 102 as the deployment destination for the processing of the workload, and the execution state (WL execution state) of the workload. Here, the information regarding the time section during which the workload is executed (has been executed) (actual WL execution time section) may include a time at which the processing of the workload has started or a time at which the processing is scheduled to start (WL execution start time or scheduled WL execution start time), and a time at which the processing of the workload has ended (has been completed) (if the processing of the workload has ended (has been completed)). In addition, the information regarding the content of the IT resources (mainly the amounts of the IT resources in the example of FIG. 13) allocated by the data center 102 as the deployment destination for the processing of the workload may include information regarding the number of central processing units (CPUs), the number of graphics processing units (GPUs), and the capacity of the memory.

Examples of a state that can be taken as the execution state (WL execution state) of the workload may include “standby for execution” that is a state before the execution start time arrives, “under execution” that is a state after the processing of the workload has started and before the processing has ended (has been completed), and “completed” that is a state after the processing of the workload has ended (has been completed).

For example, the first record of the workload execution history table 1300 in the example of FIG. 13 indicates that, for the workload to which “20240423-1” is assigned as the WL identification number (WL-ID), the identification information (data center identifier (DC-ID)) of the data center 102 as the actual deployment destination of the workload is “E-1-1-1”, the start time is 00:01:01 on Apr. 23, 2024, and the end time (completion time) is 00:02:01 on Apr. 23, 2024, and the IT resources allocated for the processing of the workload include “2” central processing units (CPUs), “1” graphics processing unit (GPU), and the memory having a capacity of “3 gigabytes (GB)”, and the execution state of the workload is “completed”.

In a case where the workload deployment destination data center is changed (workload redeployment (rebalancing or migration) is performed), the identification information (data center identifier (DC-ID)) of the actual deployment destination data center in the record of the workload execution history table 1300 for the workload may also be changed.

A lower part of FIG. 13 (a state of the workload execution history table 1300 at a time later than those in an upper part of FIG. 13 (a part above a “downward arrow” in FIG. 13) is illustrated) illustrates that, for the workload to which “20240423-87” is assigned as the WL identification number (WL-ID), the identification information (data center identifier (DC-ID)) of the actual deployment destination data center in the record of the workload execution history table 1300 for the workload is changed from “C-1” to “C-2” (redeployment (rebalancing or migration) is performed).

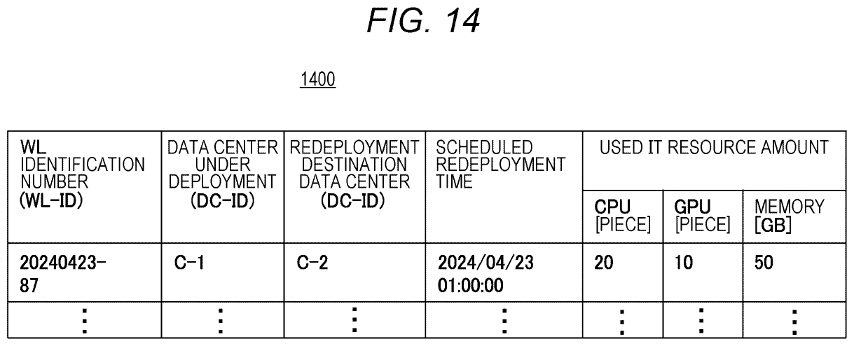

### 4-2-9. Outline of Workload Redeployment Setting Table 1400 (FIG. 14)

FIG. 14 illustrates the workload redeployment setting table 1400.

The workload redeployment setting table 1400 shows a content of a change (redeployment (rebalancing or migration)) in a case where the workload deployment destination data center is changed (redeployment (rebalancing or migration) is performed). The workload redeployment setting table 1400 may include a record corresponding to each setting (workload redeployment (rebalancing or migration) setting) of the change of the workload deployment destination data center. (However, after the redeployment (rebalancing or migration) of the workload corresponding to the record is performed and the content of the redeployment (rebalancing or migration) is reflected in the workload deployment setting table 1200 and the workload execution history table 1300, the record can be deleted from the workload redeployment setting table 1400.)

In the example of FIG. 14, the workload redeployment setting table 1400 includes, for each record, pieces of information such as the identification information (workload identification number (WL-ID)) assigned to the workload, the identification information (data center identifier (DC-ID)) of the deployment destination data center (the data center under deployment) before the redeployment, identification information (data center identifier (DC-ID)) of a redeployment destination data center, a time at which the redeployment is scheduled to be performed (scheduled redeployment time), and a content of the IT resources (mainly the amounts of the IT resources in the example of FIG. 14) allocated by the data center 102 as the redeployment destination for the processing of the workload. Here, the content of the IT resources (mainly the amounts of the IT resources in the example of FIG. 14) allocated by the data center 102 as the redeployment destination for the processing of the workload may include information regarding the number of central processing units (CPUs), the number of graphics processing units (GPUs), and the capacity of the memory.

For example, the first record of the workload redeployment setting table 1400 in the example of FIG. 14 indicates that, for the workload to which “20240423-87” is assigned as the WL identification number (WL-ID), the data center 102 as the deployment destination of the workload is changed from the data center 102 having the data center identifier (DC-ID) of “C-1” to the data center 102 having the data center identifier (DC-ID) of “C-2” (redeployment (rebalancing or migration) is performed), the scheduled redeployment time is “01:00 on Apr. 23, 2024”, and the IT resources allocated for the processing of the workload include “20” central processing units (CPUs), “10” graphics processing units (GPUs), and the memory having a capacity of “50 gigabytes (GB)”.

### 5. COMPUTER ARCHITECTURE FOR IMPLEMENTING EMBODIMENT OF PRESENT DISCLOSURE (FIG. 15)

FIG. 15 illustrates the computer architecture 1500 for implementing the system 101 according to the embodiment of the present disclosure. The computer architecture 1500 illustrated in FIG. 15 may also be referred to as an information processing device or an information processing system.

In order to implement the system 101, some or all of an arithmetic processing device 1501, the storage device 1502, the non-volatile recording medium (recording device) 1503, an external recording medium drive 1504, an input device 1506, a display or output device 1507, a communication device 1508, an external input/output port 1509, and a reading device 1510 may be interconnected by an interconnection unit 1511. (A part of or the entire interconnection unit 1511 may be a network. In this case, the system 101 is implemented by a plurality of devices via a network.)

The arithmetic processing device 1501 may be, for example, a processor. Examples of the processor include a CPU, a micro processor unit (MPU), or a GPU.

Alternatively, the processor referred to herein may be another semiconductor device as long as the semiconductor device is a subject that performs predetermined processing. Furthermore, the arithmetic processing device 1501 may be one or more (micro) processors. For example, the arithmetic processing device 1501 may be a multi-core processor including a plurality of arithmetic cores (CPU cores).

The storage device 1502 may be, for example, a memory. The non-volatile recording medium (recording device) 1503 may be, for example, a non-volatile memory (for example, a flash memory) or a non-volatile disk device. The external recording medium drive 1504 may be, for example, a disk drive. The input device 1506 may be, for example, a mouse, a keyboard, an imaging device, a sensor, a touch panel, or a pointing device. The display or output device 1507 may be, for example, a display, a printer, or a speaker. The communication device 1508 may be, for example, a communication device for wired communication or a communication device for wireless communication. The communication device 1508 may be a network interface device (NIC) that controls communication with other systems, data centers, devices, terminals, or servers according to a predetermined protocol. The interconnection unit 1511 may be, for example, a bus or a crossbar switch. (As described above, a part of or the entire interconnection unit 1511 may be a network.)

In the non-volatile recording medium (recording device) 1503, various programs (for example, programs for implementing the functional configurations according to the present disclosure such as various programs for implementing the respective functional units implemented in the system 101) included in a program group 1531, various data groups included in the data group 1532, or information included in various types of information 1533 may be recorded.

The program group 1531 may include various programs for implementing the respective functional units that are “units” in the functional configuration diagrams of FIGS. 1 and 5. Some of the above-described programs may be integrated into one program. Any one of the above-described programs may be divided into a plurality of programs.

The data group 1532 may include information (data and the like) handled by the functional unit described above. For example, the data group 1532 may include information included in each of various “tables” in the functional configuration diagram of FIG. 5. (Some or all of the pieces of information included in the various “tables” may be stored in the storage device 1502 (memory).) Alternatively, some or all of various programs included in the program group 1531, various data groups included in the data group 1532, or the information included in the various types of information 1533 may be acquired from the outside of the configuration illustrated in FIG. 15.

An external recording medium 1505 can be connected to the external recording medium drive 1504. The external recording medium 1505 may be, for example, a portable recording disk (a digital versatile disc (DVD) or the like), an integrated circuit (IC) card, a secure digital (SD) card, a non-volatile memory (for example, a flash memory), or a portable hard disk. Various programs included in the program group 1531, various data included in the data group 1532, or information similar to the information included in the various types of information 1533 may be transferred from the external recording medium 1505 and stored in the non-volatile recording medium (recording device) 1503 or the storage device 1502. The external recording medium 1505 may be used to record programs and data handled in the system 101. The external recording medium drive 1504 and the external recording medium 1505 may be connected to the system 101 illustrated in FIG. 15 via a network.

Various programs included in the program group 1531, various pieces of data included in the data group 1532, or the information included in the various types of information 1533 may be provided via the communication device 1508, the external input/output port 1509, the input device 1506, and the reading device 1510, and recorded or stored in the non-volatile recording medium (recording device) 1503 or the storage device 1502.

In order for the architecture of FIG. 15 to function as the system 101, each functional unit in the system 101, or a portion of each functional unit (to execute one or a series of processing (steps)), various programs included in the program group 1531 may be loaded into the storage device 1502 (for example, from the non-volatile recording medium (recording device) 1503). The loaded program is indicated by 1521 in FIG. 15. Then, the arithmetic processing device 1501 may execute the program 1521 (by using various pieces of data or the like included in the data group 1532 existing in the non-volatile recording medium (recording device) 1503 or the like, or the information included in the various types of information 1533 as necessary). The functions of the system 101, each functional unit in the system 101, or a portion of each functional unit are implemented (one or a series of processing (steps) is performed) by executing the program 1521. At this time, the various buffers 1523 temporarily formed in the storage device 1502 may also be used as appropriate.

### 6. Processing Performed in Embodiment of Present Disclosure

Hereinafter, the processing performed in the embodiment (system 101) of the present disclosure will be described. It is not essential to implement all the functional configurations described below and perform all the steps of processing. In addition, the implementation of a functional configuration other than the functional configuration and processing described below, and execution of the processing are not precluded.

Furthermore, a method executed by the system (the information processing device or the information processing system) may be formed by combining the steps of the processing described below.

In the flowcharts illustrated in FIGS. 16, 17, 18, 19, and 20, the same numbers surrounded by circles are connected to each other.

### 6-1. Processing in Workload Actual Record Table Creation Unit (FIG. 16)

FIG. 16 is a flowchart of the processing performed by the workload actual record table creation unit 1600. Hereinafter, the processing will be described in the order illustrated in FIG. 16. Each of processing steps performed by the workload actual record table creation unit 1600 in the flowchart of FIG. 16 may be understood to form a “workload actual record table creation step”.

As the functions described below are implemented, it is possible to create the workload actual record table 800 including a record appropriately reflecting the actual record of the reception of the workload execution request 211 and the actual record of the processing of the workload associated with the workload execution request 211. As described above, the workload actual record table 800 including the record appropriately reflecting the actual record related to the workload is created, so that information for performing the prediction 109 regarding the workload can be prepared.

In step 1601 of FIG. 16, the workload actual record table creation unit 1600 determines whether or not it is time to record a new record in the workload actual record table 800. More specifically, the workload actual record table creation unit 1600 determines whether or not a record in which the workload execution state is “completed” has been newly generated in the workload execution history table 1300 illustrated in FIG. 13. If a determination result of step 1601 is affirmative, the control proceeds to step 1602. If the determination result of step 1601 is negative, step 1601 is repeated.

In step 1602 of FIG. 16, the workload actual record table creation unit 1600 acquires, from the workload execution history table 1300, information regarding the new record in which the workload execution state is determined to be “completed” in step 1601. Then, the workload actual record table creation unit 1600 grasps information regarding the identification information (workload identification number (WL-ID)) of the workload, the actual deployment destination data center (DC-ID), the start time (of the processing of the workload), and the end time (of the processing of the workload) included in the acquired information regarding the record.

In step 1603 of FIG. 16, the workload actual record table creation unit 1600 calculates a time actually required for the processing of the workload (actual required time) based on the start time (of the processing of the workload) and the end time (of the processing of the workload) grasped in step 1602.

In step 1604 of FIG. 16, the workload actual record table creation unit 1600 specifies one of the records of the workload execution request buffer table 1100 illustrated in FIG. 11 by using the identification information (workload identification number (WL-ID)) of the workload grasped in step 1602. The workload actual record table creation unit 1600 acquires information regarding the specified record from the workload execution request buffer table 1100. The workload actual record table creation unit 1600 grasps the date and time when the workload execution request 211 has been received by the system 101 (workload execution request reception date and time), the constraint and the requirement imposed on the data center 102 serving as the processing subject when processing the workload, and the content of the IT resources (mainly the amounts of the IT resources in the example of FIG. 11) used when processing the workload included in the acquired information of the record. At this time, the workload actual record table creation unit 1600 may also grasp the information regarding the time (allowable execution delay time) by which the delay is allowed when performing the processing of the workload.

In step 1605 of FIG. 16, the workload actual record table creation unit 1600 newly adds a record reflecting the actual record of the reception of the workload execution request 211 and the actual record of the processing of the workload associated with the workload execution request 211 to the workload actual record table 800 illustrated in FIG. 8. Specifically, the workload actual record table creation unit 1600 may store the newly added record in the workload actual record table 800 after including, in the newly added record, the date and time when the workload execution request 211 has been received by the system 101 (workload execution request reception date and time) grasped in step 1604, the constraint and the requirement imposed on the data center 102 serving as the processing subject when processing the workload grasped in step 1604, the content of the IT resources (mainly the amount of IT resource in the example of FIG. 11 or FIG. 13) used when processing the workload grasped in step 1604 (or step 1602), the data center identifier (DC-ID) of the actual deployment destination data center grasped in step 1602, and the time actually required for processing the workload (actual required time) calculated in step 1603.

After step 1605 of FIG. 16, the control returns to step 1601.

If the data center identifier (DC-ID) of the actual deployment destination data center in the above-described information is not used for the processing in the workload prediction unit 1700, the workload actual record table creation unit 1600 does not have to handle the data center identifier (DC-ID) of the actual deployment destination data center in the processing illustrated in FIG. 16.

### 6-2. Processing in Workload Prediction Unit (FIG. 17)

FIG. 17 illustrates a flowchart of the processing performed by the workload prediction unit 1700.

Hereinafter, the processing will be described in the order illustrated in FIG. 17. Each of processing steps performed by the workload prediction unit 1700 in the flowchart of FIG. 17 may be understood to form a “workload prediction step”.

As the functions described below are implemented, it is possible to create the prediction 109 of the workload appropriately reflecting the actual record of the reception of the workload execution request 211 and the actual record of the processing of the workload associated with the workload execution request 211 included in the workload actual record table 800. In addition, since the prediction 109 of the workload to be created is a prediction corresponding to each time zone in the data center operation mode plan 110, it is easy to create the data center operation mode plan 110 using the workload prediction table 900 storing information regarding the prediction 109 of the workload.

In step 1701 of FIG. 17, the workload prediction unit 1700 determines whether or not it is time to newly create the prediction 109 of the workload. For example, the workload prediction unit 1700 may set, as a timing of newly creating the prediction 109 regarding the workload, an arbitrary timing before a timing of newly creating the data center operation mode plan 110. Specifically, for example, if the data center operation mode plan 110 includes a period of 24 hours (one day) from 00:00 to 24:00 and the data center operation mode plan 110 is created at 23:30 on the previous day (if the data center operation mode plan 110 is created at 23:30 every day), the creation of the prediction 109 of the workload (the creation of the new workload prediction table 900) may be performed at 23:00 on the previous day (at 23:00 every day).

Alternatively, for example, if the data center operation mode plan 110 includes a period of 168 hours (seven days) from every Sunday 00:00 to every Saturday 24:00 and the data center operation mode plan 110 is created at 23:30 on every Saturday, the creation of the prediction 109 of the workload (the creation of the new workload prediction table 900) may be performed at 23:00 on every Saturday. A period for setting the operation mode 103 according to the entire data center operation mode plan 110 may have a length other than 24 hours (one day) or 168 hours (seven days) described above. If a determination result of step 1701 is affirmative, the control proceeds to step 1702. If the determination result of step 1701 is negative, step 1701 is repeated.

In step 1702 of FIG. 17, the workload prediction unit 1700 selects one of time zones that are time units for the control of the operation mode 103 in the data center operation mode plan 110. For example, a length of the time zone in the data center operation mode plan 110 may be 1 hour or 4 hours (or may be any other length). For example, in a case where the length of the time period in the data center operation mode plan 110 is 1 hour and the length of the period for setting the operation mode 103 according to the entire data center operation mode plan 110 is 24 hours (one day from 00:00 to 24:00), in step 1702, the workload prediction unit 1700 may select one of a time period from 00:00 to 01:00, a time period from 01:00 to 02:00, . . . , and a time period from 23:00 to 24:00. Alternatively, in a case where the length of the time period in the data center operation mode plan 110 is 1 hour and the length of the period for setting the operation mode 103 according to the entire data center operation mode plan 110 is 168 hours (seven days, for example, from 00:00 on Sunday to 24:00 on Saturday), in step 1702, the workload prediction unit 1700 may select one of a time period from 00:00 to 01:00 on Sunday, a time period from 01:00 to 02:00 on Sunday, and a time period from 23:00 to 24:00 on Saturday.

In step 1703 of FIG. 17, the workload prediction unit 1700 acquires information to be used to create the prediction 109 regarding the workload in the time zone selected in step 1702 from the workload actual record table 800 illustrated in FIG. 8. The workload prediction unit 1700 may acquire, from the workload actual record table 800, a record related to the actual record of the reception of the workload execution request 211 or the actual record of the processing of the workload associated with the workload execution request 211 in a past certain period (for example, the latest one month). Specifically, the workload prediction unit 1700 may acquire a record group corresponding to the time zone selected in step 1702 from the workload actual record table 800. For example, if the time zone selected in step 1702 is the time zone from 00:00 to 01:00, in step 1703, the workload prediction unit 1700 may acquire a record group in which the workload execution request reception date and time is included in a range from 00:00 to 01:00 (for example, any one of dates included in the latest one month) from the workload actual record table 800. Alternatively, for example, if the time zone selected in step 1702 is the time zone from 00:00 to 01:00 on Sunday, in step 1703, the workload prediction unit 1700 may acquire a record group in which the workload execution request reception date and time is included in a range from 00:00 to 01:00 on any Sunday (included in the latest one month, for example) from the workload actual record table 800.

In step 1704 of FIG. 17, the workload prediction unit 1700 selects one of possible settings as the constraint and the requirement imposed on the data center 102 serving as the processing subject when processing the workload included in the record group acquired in step 1703. Here, the constraint and the requirement imposed on the data center 102 serving as the processing subject when executing the workload may be a combination of the “deployable data center” and the level of the availability required when processing the workload. That is, in step 1703, one of the possible settings may be selected as the combination of the “deployable data center” and the level of the availability.

Referring to the example of FIG. 8, for example, a combination of any one of “C-1”, “C-2”, “C-3”, “R-1-1”, “R-1-2”, and “E-1-1-1” as the data center identifier (DC-ID) of the “deployable data center”, and “1 or higher (such as 1, 2, or 3)” as the level of the availability may be selected. Alternatively, a combination of any one of “C-1”, “C-2”, “C-3”, “R-1-1”, and “R-1-2” as the data center identifier (DC-ID) of the “deployable data center”, and “2 or higher (such as 2 or 3)” as the level of the availability may be selected. Alternatively, a combination of any one of “C-1”, “C-2”, and “C-3” as the data center identifier (DC-ID) of the “deployable data center”, and “3 or higher (such as 3 or 4)” as the level of the availability may be selected.

In step 1705 of FIG. 17, the workload prediction unit 1700 extracts a record group corresponding to one of the possible settings as the constraint and the requirement imposed on the data center 102 serving as the processing subject when processing the workload selected in step 1704 in the record group acquired in step 1703. Then, the workload prediction unit 1700 sums up combinations of the content (here, mainly the amount of the IT resource) of the IT resource used to process the workload and the actual required time for the extracted record group.

Referring to the example of FIG. 8, in step 1704, in a case where the combination of any one of “C-1”, “C-2”, “C-3”, “R-1-1”, “R-1-2”, and “E-1-1-1” as the data center identifier (DC-ID) of the “deployable data center” and “1 or higher (such as 1, 2, or 3)” as the level of the availability is selected as the combination of the “deployable data center” and the level of the availability, the workload prediction unit 1700 extracts a record group having a value of the above-described combination in step 1705. Then, the workload prediction unit 1700 sums up the products of a value indicated by the amount of the IT resource (the number of central processing units (CPUs), the number of graphics processing units (GPUS), and the capacity of the memory) and a value of the actual required time in each record included in the extracted record group. The summed result may be, for example, a set of a parameter expressed in the form of the number of central processing units (CPUs), a parameter expressed in the form of the number of graphics processing units (GPUS), a parameter expressed in the form of the capacity of the memory, and a parameter expressed in the form of the actual required time. In addition, the total value may be calculated, for example, for each day when the workload has been processed.

In step 1706 of FIG. 17, the workload prediction unit 1700 calculates prediction values of the content of the IT resources (here, mainly the amounts of the IT resources) used to process the workload group and the required time corresponding to one of the possible settings as the constraint and the requirement imposed on the data center 102 as the processing subject when processing the workload selected in step 1702 in the time zone selected in step 1704. For example, the workload prediction unit 1700 may calculate the prediction values by performing predetermined processing on the total value (for example, represented by the set of the parameter expressed in the form of the number of central processing units (CPUs), the parameter expressed in the form of the number of graphics processing units (GPUs), the parameter expressed in the form of the capacity of the memory, and the parameter expressed in the form of the actual required time) calculated in step 1705 (for example, for each day when the workload has been processed). The predetermined processing here may be any processing as long as the prediction values are calculated, and may be, for example, processing by an autoregression method or processing using a least squares method (LSM). (The prediction value of the required time may be made equal to the length of the time zone (for example, one hour).)

In step 1707 of FIG. 17, the workload prediction unit 1700 stores a record including the prediction value calculated in step 1706 corresponding to one of the possible settings as the constraint and the requirement imposed on the data center 102 serving as the processing subject when processing the workload selected in step 1704 in the time zone selected in step 1702 in the workload prediction table 900 illustrated in FIG. 9. (In a case where the required time has the same value as the length of the time zone (for example, one hour), information indicating the required time does not have to be included in the record of the workload prediction table 900.)

As illustrated in FIG. 9, in the workload prediction table 900, the record is provided for each combination of the time zone and the possible setting as the constraint and the requirement imposed on the data center 102.

In step 1708 of FIG. 17, the workload prediction unit 1700 determines whether or not all the possible settings as the constraint and the requirement imposed on the data center 102 serving as the processing subject when processing the workload included in the record group acquired in step 1703 have been selected in step 1704. If a determination result of step 1708 is affirmative, the control proceeds to step 1709. If the determination result of step 1708 is negative, the control returns to step 1704, and another one of the possible settings as the constraint and the requirement imposed on the data center 102 serving as the processing subject when processing the workload is selected.

In step 1709 of FIG. 17, the workload prediction unit 1700 determines whether or not all the time zones that are time units for setting the operation mode 103 in the data center operation mode plan 110 have been selected in step 1702. If a determination result of step 1709 is affirmative, the control returns to step 1701, and the workload prediction unit 1700 substantially waits until it is time to create the prediction 109 regarding the next workload. If the determination result of step 1709 is negative, the control returns to step 1702, and a time zone that has not yet been selected is newly selected.

### 6-3. Processing in Data Center Operation Mode Plan Creation Unit (FIG. 18)

FIG. 18 is a flowchart of the processing performed by the data center operation mode plan creation unit 1800. Hereinafter, the processing will be described in the order illustrated in FIG. 18. Each of processing steps performed by the data center operation mode plan creation unit 1800 in the flowchart of FIG. 18 may be understood to form a “data center operation mode plan creation step”. As the functions described below are implemented, it is possible to create the data center operation mode plan 110 in consideration of a priority while appropriately coping with the prediction 109 regarding the workload shown in the workload prediction table 900.

In step 1801 of FIG. 18, the data center operation mode plan creation unit 1800 determines whether or not it is time to newly create the data center operation mode plan 110. For example, the data center operation mode plan creation unit 1800 may set an arbitrary timing before the entire period (for example, a period of 24 hours (one day) or a period of 168 hours (seven days)) using the setting of the operation mode 103 according to the data center operation mode plan 110 as a timing of newly creating the data center operation mode plan 110. Specifically, for example, if the data center operation mode plan 110 includes a period of 24 hours (one day) from 00:00 to 24:00, the creation of the data center operation mode plan 110 may be performed at 23:30 on the previous day (may be performed at 23:30 every day). Alternatively, for example, if the data center operation mode plan 110 includes a period of 168 hours (seven days) from every Sunday 00:00 to every Saturday 24:00, the creation of the data center operation mode plan 110 may be performed at 23:30 on every Saturday. A period for setting the operation mode 103 according to the entire data center operation mode plan 110 may have a length other than 24 hours (one day) or 168 hours (seven days) described above. If a determination result of step 1801 is affirmative, the control proceeds to step 1802. If the determination result of step 1801 is negative, step 1801 is repeated.

In step 1802 of FIG. 18, the data center operation mode plan creation unit 1800 selects one of the time zones that are time units for the control of the operation mode 103 in the data center operation mode plan 110. For example, a length of the time zone in the data center operation mode plan 110 may be 1 hour or 4 hours (or may be any other length). For example, in a case where the length of the time period in the data center operation mode plan 110 is 1 hour and the length of the period for setting the operation mode 103 according to the entire data center operation mode plan 110 is 24 hours (one day from 00:00 to 24:00), in step 1802, the data center operation mode plan creation unit 1800 may select one of the time period from 00:00 to 01:00, the time period from 01:00 to 02:00, and the time period from 23:00 to 24:00. Alternatively, in a case where the length of the time period in the data center operation mode plan 110 is 1 hour and the length of the period for setting the operation mode 103 according to the entire data center operation mode plan 110 is 168 hours (seven days from 00:00 on Sunday to 24:00 on Saturday), in step 1802, the data center operation mode plan creation unit 1800 may select one of the time period from 00:00 to 01:00 on Sunday, the time period from 01:00 to 02:00 on Sunday, . . . , and the time period from 23:00 to 24:00 on Saturday.

In step 1803 of FIG. 18, the data center operation mode plan creation unit 1800 acquires a record group indicating the prediction 109 regarding the workload in the time zone selected in step 1802 from the workload prediction table 900 illustrated in FIG. 9. For example, if the time zone selected in step 1802 is the time zone from 00:00 to 01:00, in step 1803, the data center operation mode plan creation unit 1800 may acquire a record group for which the time zone from 00:00 to 01:00 is set from the workload prediction table 900. Alternatively, if the time zone selected in step 1802 is the time zone from 00:00 to 01:00 on Sunday, in step 1803, the data center operation mode plan creation unit 1800 may acquire a record group for which the time zone from 00:00 to 01:00 on Sunday is set from the workload prediction table 900.

In step 1804 of FIG. 18, the data center operation mode plan creation unit 1800 selects one of combinations of possible settings of the operation modes 103 for each of the data centers 102 targeted by the data center operation mode plan 110. Referring to the example of FIG. 7, for example, the data center operation mode plan creation unit 1800 may select a combination of “1” set as the operation mode 103 of the data center 102 with the data center identifier (DC-ID) of “C-1”, “2” set as the operation mode 103 of the data center 102 with the data center identifier (DC-ID) of “C-2”, “3” set as the operation mode 103 of the data center 102 with the data center identifier (DC-ID) of “C-3”, “0” set as the operation mode 103 of the data center 102 with the data center identifier (DC-ID) of “R-1-1”, “2” set as the operation mode 103 of the data center 102 with the data center identifier (DC-ID) of “R-1-2”, “3” set as the operation mode 103 of the data center 102 with the data center identifier (DC-ID) of “R-2-1”, “1” set as the operation mode 103 of the data center 102 with the data center identifier (DC-ID) of “R-2-2”, “2” set as the operation mode 103 of the data center 102 with the data center identifier (DC-ID) of “E-1-1-1”, and “1” set as the operation mode 103 of the data center 102 with the data center identifier (DC-ID) of “E-1-2-1”.

In performing step 1804, the data center operation mode plan creation unit 1800 may select combinations in descending order of the priority level. The data center operation mode list table 700 illustrated in FIG. 7 shows a value of an index corresponding to a combination of the data center identifier (DC-ID) and the operation mode 103 (operation mode number). Here, the index corresponding to the combination of the data center identifier (DC-ID) and the operation mode 103 (operation mode number) may be the unit price of the cost in the operation mode 103, the ratio of the power amount (green-derived power amount) from the power generation source with a relatively low carbon emission to the power consumption in the operation mode 103, and the index related to the adjustment compensation (the compensation that can be received by the person operating the base 202 and the data center 102 from the supply-demand balancing market by reducing the power amount received by the base 202 and the data center 102 from the power transmission and distribution system 370) in the operation mode 103. The priority levels may be set for such three indices. For example, the highest priority (Priority Level 1) may be associated with the unit price of the cost. The second highest priority (Priority Level 2) may be associated with the ratio of the green-derived power amount. The third highest priority (Priority Level 3) may be associated with the index related to the adjustment compensation. The data center operation mode plan creation unit 1800 sequentially selects the combinations of the possible settings of the operation modes 103 for each of the data centers 102 in order of more favorable indices.

In step 1805 of FIG. 18, the data center operation mode plan creation unit 1800 selects one record (the record of the workload prediction table 900) from the record group acquired in step 1803. The data center operation mode plan creation unit 1800 grasps information regarding the constraint and the requirement imposed on the data center 102 serving as the processing subject when processing the workload, information regarding the content (amount) of the IT resources used to process the workload and information regarding the required time included in the selected record.

For example, in the example of FIG. 9, in a case where the first record of the workload prediction table 900 is selected in step 1805, the data center operation mode plan creation unit 1800 grasps that the data center identifier (DC-ID) of the “deployable data center” is any one of “C-1”, “C-2”, “C-3”, “R-1-1”, “R-1-2”, and “E-1-1-1”, and the level of the availability required when processing the workload is “1 or higher (such as 1, 2, or 3)”, as the constraint and the requirement imposed on the data center 102 serving as the processing subject when processing the workload. In addition, the data center operation mode plan creation unit 1800 grasps that the total amount of the workload to be processed by the information processing resources including 10000 central processing units (CPUs), 1000 graphics processing units (GPUs), and the memory having a capacity of 7500 gigabytes (GB) for 3600 seconds is predicted as the IT resource amount and the required time used to process the workload.

In step 1806 of FIG. 18, the data center operation mode plan creation unit 1800 attempts to (virtually) allocate a workload group of the prediction indicated by the record (of the workload prediction table 900) selected in step 1805 to each data center 102 on the assumption of the combination of the operation modes 103 for each data center 102 selected in step 1804. Specifically, the data center operation mode plan creation unit 1800 attempts to virtually secure a combination of the IT resource amount and the time (that can be provided corresponding to the operation mode 103) equivalent to the combination of the IT resource amount and the required time used to process the workload group indicated by the record (of the workload prediction table 900) selected in step 1805 in one or more of the data centers 102 that satisfy the constraint and the requirement imposed on the data center 102 serving as the processing subject when processing the workload group, indicated by the record (of the workload prediction table 900) selected in step 1805.

For example, in the example of FIG. 9, in a case where the first record of the workload prediction table 900 is selected in step 1805, in step 1806, the data center operation mode plan creation unit 1800 specifies the data center 102 whose data center identifier (DC-ID) is any one of “C-1”, “C-2”, “C-3”, “R-1-1”, “R-1-2”, and “E-1-1-1” and whose level of the availability achievable for the processing of the workload is “1 or higher (such as 1, 2, or 3)” (at this time, the data center operation mode list table 700 may be referred to). Then, the data center operation mode plan creation unit 1800 attempts to virtually secure an available resource corresponding to the total amount of the workload to be processed by the information processing resources including 10000 central processing units (CPUs), 1000 graphics processing units (GPUs), and the memory having a capacity of 7500 gigabytes (GB) as a whole for 3600 seconds in one or more of the specified data centers 102 (at this time, the data center list table 600 and the data center operation mode list table 700 may be referred to).

In step 1807 of FIG. 18, the data center operation mode plan creation unit 1800 determines whether or not the virtual allocation (virtual securing of the available resource) attempted in step 1806 has succeeded. If a determination result of step 1807 is affirmative, the control proceeds to step 1810. If the determination result of step 1807 is negative, the control proceeds to step 1808.

In step 1808 of FIG. 18, (in response to the negative determination result in step 1807 indicating that the combination of the operation modes 103 for each data center 102 selected when step 1804 was performed most recently cannot cope with the prediction 109 regarding the workload in the time zone selected when step 1802 was performed most recently), the data center operation mode plan creation unit 1800 determines whether or not all the possible combinations of the operation modes 103 of the data centers 102 have been selected in step 1804 for the time zone selected when step 1802 was performed most recently. If a determination result of step 1808 is affirmative, the control proceeds to step 1809. If the determination result of step 1808 is negative, the control returns to step 1804, and one of the combinations of the operation modes 103 for each data center 102 that have not yet been selected is newly selected.

In step 1809 of FIG. 18, the data center operation mode plan creation unit 1800 issues an alert indicating that the creation of the data center operation mode plan 110 has failed to a user of the system 101 (because the execution of step 1809 of FIG. 18 means that the combination of the operation modes 103 for each data center 102 that can cope with the prediction 109 regarding the workload in the time zone selected when step 1802 was performed most recently cannot be found). Thereafter, the user of the system 101 takes an action for the alert.

In step 1810 of FIG. 18, (in response to the affirmative determination result of step 1807,) the data center operation mode plan creation unit 1800 determines whether or not all the records included in the record group (of the workload prediction table 900) acquired when step 1803 was performed most recently have been selected in step 1805. If a determination result of step 1810 is affirmative, the control proceeds to step 1811. If the determination result of step 1810 is negative, the control returns to step 1805 to newly select one of the records that have not yet been selected.

In step 1811 of FIG. 18, the data center operation mode plan creation unit 1800 stores information regarding the combination of the operation modes 103 (operation mode numbers) for each data center 102 in the time zone selected when step 1802 was performed most recently in the data center operation mode plan table 1000 illustrated in FIG. 10 (because the execution of step 1811 of FIG. 18 means that the combination of the operation modes 103 for each data center 102 that can cope with the prediction 109 regarding the workload in the time zone selected when step 1802 was performed most recently can be found). At this time, the information regarding the combination of the operation modes 103 (operation mode numbers) for each data center 102 is information indicating the combination of the operation modes 103 for each data center 102 selected when step 1804 was performed most recently.

In step 1812 of FIG. 18, the data center operation mode plan creation unit 1800 determines whether or not all the time zones that are the time units for the control of the operation mode 103 in the data center operation mode plan 110 have been selected in step 1802. If a determination result of step 1812 is affirmative, since the creation of the data center operation mode plan 110 has been completed, the control returns to step 1801, and the processing in the data center operation mode plan creation unit 1800 is substantially in a standby state until it is time to create the data center operation mode plan 110 next. If the determination result of step 1812 is negative, the control returns to step 1802 to newly select one of the time zones that have not yet been selected.

### 6-4. Processing in Data Center Operation Mode Control Information Transmission Unit (FIGS. 5 and 10)

Information regarding the setting of the operation mode 103 for each time zone and each data center 102 stored in the data center operation mode plan table 1000 is delivered to each data center 102. The data center operation mode control information transmission unit 510 serves to generate and transmit information (data center operation mode control information 210 (DC-mode)) used for the delivery.

The data center operation mode control information transmission unit 510 may create the data center operation mode control information 210 (DC-mode) addressed to each of the data centers 102 targeted by the data center operation mode plan 110 based on the information stored in the data center operation mode plan table 1000 illustrated in FIG. 10. Each piece of data center operation mode control information 210 (DC-mode) may include the identification information of the base 202 as the destination of the data center operation mode control information 210 (DC-mode), the identification information (data center identifier (DC-ID)) of the data center 102 as the destination, identification information of the time zone, and a value (operation mode number) of the operation mode 103 (set in the time zone).

The data center operation mode control information transmission unit 510 may create the data center operation mode control information 210 (DC-mode) for each combination of the time zone and the data center 102 as the destination of the data center operation mode control information 210 (DC-mode), and then transmit the data center operation mode control information 210 (DC-mode).

Alternatively, the data center operation mode control information transmission unit 510 may create one piece of data center operation mode control information 210 (DC-mode) for the data center 102 as the destination for several time zones or all the time zones (targeted by the data center operation mode plan 110), and then transmit the data center operation mode control information 210 (DC-mode). In this case, one piece of data center operation mode control information 210 (DC-mode) includes a plurality of sets of the identification information of the time zone and the value (operation mode number) of the operation mode 103 (set in the time zone).

Further, the data center operation mode control information transmission unit 510 may collectively create one piece of data center operation mode control information 210 (DC-mode) for the plurality of data centers 102 included in the same base 202, and then transmit the data center operation mode control information 210 (DC-mode). In this case, a plurality of pieces of identification information (data center identifiers (DC-IDs)) of the data centers 102 as the destinations are included in the one piece of data center operation mode control information 210 (DC-mode), and one or more sets of the identification information of the time zone and the value (operation mode number) of the operation mode 103 (set in the time zone) are included for each data center 102.

The processing performed by the data center operation mode control information transmission unit 510 may be understood to form a “data center operation mode control information transmission step”.

Since the functions as described above are implemented by the data center operation mode control information transmission unit 510, the information regarding the setting of the operation mode 103 for each time zone and each data center 102 stored in the data center operation mode plan table 1000 can be delivered to each data center 102. Each of the data centers 102 can operate in the operation mode 103 according to the data center operation mode plan 110.

### 6-5. Processing in Workload Execution Request Reception Unit (FIGS. 5 and 11)

The workload execution request 211 from the execution request device 105 is received by the system 101, a record including information regarding the workload execution request 211 is generated, and the generated record is stored in the workload execution request buffer table 1100. The workload execution request reception unit 511 is responsible for the reception, generation, and storage.

As described above, the workload execution request buffer table 1100 may store the record illustrated in FIG. 11 for each workload execution request 211 received by the system 101.

Among pieces of information included in the record illustrated in FIG. 11, the identification information (WL identification number (WL-ID)) of the workload may be assigned by the workload execution request reception unit 511 itself, another functional unit of the system 101, or the like. (In a case where the execution request device 105 serving as the issuing source of the workload execution request 211, previously assigns the identification information (WL identification number (WL-ID)) of the workload, the previously assigned identification information may be diverted in the system 101.)

Among the pieces of information included in the record illustrated in FIG. 11, the date and time when the workload execution request 211 has been received (WL execution request reception date and time) may be assigned by the workload execution request reception unit 511 itself or another functional unit of the system 101.

Among the pieces of information included in the record illustrated in FIG. 11, each of the constraint and the requirement imposed on the data center 102 serving as the processing subject when the workload is processed, the content of the IT resources used when processing the workload (mainly the amounts of the IT resources in the example of FIG. 11), the time by which the delay is allowed when processing the workload (allowable execution delay time), and the time estimated to be required when the workload is processed (estimated required time) may be based on information explicitly assigned to the workload execution request 211 itself, or may be based on a determination result derived by the workload execution request reception unit 511 by some determination.

After generating the record including the information regarding the received workload execution request 211, the workload execution request reception unit 511 stores the record in the workload execution request buffer table 1100.

The processing performed by the workload execution request reception unit 511 may be understood to form a “workload execution request reception step”.

Since the functions as described above are implemented by the workload execution request reception unit 511, it is possible to generate a record including information easily used by other functional units included in the system 101 as the information regarding the workload execution request 211 received by the system 101 and store the record in the workload execution request buffer table 1100.

### 6-6. Processing in Workload Deployment Setting Unit (FIG. 19)

FIG. 19 is a flowchart of the processing performed by the workload deployment setting unit 1900. Hereinafter, the processing will be described in the order illustrated in FIG. 19. Each of processing steps performed by the workload deployment setting unit 1900 in the flowchart of FIG. 19 may be understood to form a “workload deployment setting step”.

Since the functions as described below are implemented, it is possible to perform setting for appropriately deploying the workload to any one of the data centers 102 while matching the condition when processing the workload associated with the workload execution request 211 received by the system 101 with the operation mode 103 for each data center 102 based on the data center operation mode plan 110.

In step 1901 of FIG. 19, the workload deployment setting unit 1900 determines whether or not a new record for the workload execution request 211 has been stored in the workload execution request buffer table 1100. If a determination result of step 1901 is affirmative, the control proceeds to step 1902. If the determination result of step 1901 is negative, step 1901 is repeated.

In step 1902 of FIG. 19, the workload deployment setting unit 1900 acquires information regarding the new record that is a determination target of step 1901 from the workload execution request buffer table 1100. The workload deployment setting unit 1900 grasps the constraint and the requirement (the data center identifier (DC-ID) of the “deployable data center” and the level of the availability required when the workload is processed in the example of FIG. 11) imposed on the data center 102 serving as the processing subject when the workload is processed, the time by which the delay is allowed when the workload is processed (allowable execution delay time), the content of the IT resources used when processing the workload (mainly the amounts of the IT resources in the example of FIG. 11), and the time estimated to be required when the workload is processed (estimated required time) based on the acquired information regarding the record.

In step 1903 of FIG. 19, the workload deployment setting unit 1900 specifies a time zone in which the workload can be deployed (processed) based on the allowable execution delay time grasped in step 1902. For example, if the allowable execution delay time is “immediate” (a setting in which the delay of the execution is not allowed), the time zone in which the workload can be deployed (processed) may be only a time zone including a time at which step 1903 is performed. (Alternatively, if the time is close to the end of the time zone, the next time zone may be set as the time zone in which the workload can be deployed (processed).) In addition, if the allowable execution delay time is set to, for example, “up to 2 hours later”, the time zone in which the workload can be deployed (processed) may be a plurality of time zones including a time section from the time at which step 1903 is performed (or a generation time or a reception time of the workload execution request 211) to 2 hours after the time. The allowable execution delay time may be set in any one of units of hours, units of minutes, and the like.

Alternatively, the setting of the allowable execution delay time may be a setting such as “up to a specific time”.

In step 1904 of FIG. 19, the workload deployment setting unit 1900 specifies the data center 102 (or the data centers 102) satisfying the constraint and the requirement (the data center identifier (DC-ID) of the “deployable data center” and the level of the availability required when the workload is processed in the example of FIG. 11) imposed on the data center 102 serving as the processing subject when the workload is processed, the constraint and the requirement being grasped in step 1902, within a range of one or more time zones specified in step 1903.

The operation mode 103 is set for each time zone in each data center 102. Therefore, each of the data centers 102 can have different levels of availability achievable when processing the workload for each time zone.

Therefore, the workload deployment setting unit 1900 may grasp the setting of the operation mode 103 for each time zone and each data center 102 by referring to the data center operation mode plan table 1000, and then grasp the level of the availability achievable when processing the workload according to (a combination of the data center 102 and) the grasped operation mode 103 by referring to the data center operation mode list table 700.

In step 1905 of FIG. 19, the workload deployment setting unit 1900 selects one of the combinations of the time zone specified in step 1903 and the data center 102 specified in step 1904. (The combination is limited to that specified in step 1904.)

In step 1906 of FIG. 19, the workload deployment setting unit 1900 acquires information regarding the combination of the time zone and the data center 102 selected in step 1905 from each of the data center list table 600, the data center operation mode list table 700, the data center operation mode plan table 1000, and the workload execution history table 1300.

Specifically, the workload deployment setting unit 1900 may acquire information regarding the content (the number of central processing units (CPUs), the number of graphics processing units (GPUs), and the capacity of the memory in the example of FIG. 6) of the IT resources held by the data center from the record related to the data center 102 related to the combination in the data center list table 600.

The workload deployment setting unit 1900 may acquire the value (operation mode number) of the operation mode 103 from the record related to the data center 102 and the time zone related to the combination in the data center operation mode plan table 1000.

From the record related to the data center 102 and the operation mode 103 (in the time zone) related to the combination in the data center operation mode list table 700, the workload deployment setting unit 1900 may acquire information regarding the proportion of the content (amount) of the IT resources providable for the processing of the workload to the content (total amount) of the IT resources held by the data center 102.

The workload deployment setting unit 1900 may acquire information (for example, information regarding the amounts of the allocated IT resources and the time) regarding the execution history and the execution state of another workload that has already been deployed to the data center 102 from a record group related to the data center 102 related to the combination in the workload execution history table 1300.

In step 1907 of FIG. 19, the workload deployment setting unit 1900 calculates amounts (available amounts) of the content (for example, the amounts, specifically, the number of central processing units (CPUs), the number of graphics processing units (GPUs), and the capacity of the memory) of the IT resource providable for the processing of the workload in the data center 102 and the time that are not allocated to another workload based on the information acquired in step 1906 for the combination of the time zone and the data center 102 selected in step 1905.

Specifically, in step 1906, the workload deployment setting unit 1900 can specify, based on the information acquired from the data center list table 600, the information acquired from the data center operation mode plan table 1000, and the information acquired from the data center operation mode list table 700, the content (for example, the amounts, specifically, the number of central processing units (CPUs), the number of graphics processing units (GPUs), and the capacity of the memory) of the IT resources providable for the processing of the workload in the data center 102 and the time.

In addition, in step 1906, the workload deployment setting unit 1900 can specify, based on the information acquired from the workload execution history table 1300, the amount of the IT resource that has been allocated to another workload in the content of the IT resources providable for the processing of the workload in the data center 102 and the time.

Therefore, the workload deployment setting unit 1900 can calculate the unallocated amount (available amount).

In step 1908 of FIG. 19, the workload deployment setting unit 1900 determines whether or not the unallocated amount (available amount) calculated in step 1907 is equal to or more than that indicated by the combination of the content (amount) of the IT resources used to process the workload associated with the workload execution request 211 received by the system 101 and the estimated required time. If a determination result of step 1908 is affirmative, the control proceeds to step 1911. If the determination result of step 1908 is negative, the control proceeds to step 1909.

In step 1909 of FIG. 19, (in response to the fact that the workload associated with the workload execution request 211 cannot be deployed to the combination of the time zone and the data center 102 selected in the most recent step 1905,) the workload deployment setting unit 1900 determines whether or not all the combinations of the time zone and the data center 102 specified in steps 1903 and 1904 have been selected in step 1905. If a determination result of step 1909 is affirmative, the control proceeds to step 1910. If the determination result of step 1909 is negative, the control returns to step 1905 to newly select one of the combinations of the time zone and the data center 102 that have not yet been selected.

In step 1910 of FIG. 19, (in response to the determination result indicating that the workload associated with the workload execution request 211 cannot be deployed for all the combinations of the time zone and the data center 102 specified in steps 1903 and 1904,) the workload deployment setting unit 1900 issues an alert indicating that the deployment (deployment) of the workload associated with the workload execution request 211 has failed. This alert may be provided to the user of the system 101. In addition, this alert may be provided to the execution request device 105 serving as the issuing source of the workload execution request 211. Alternatively, this alert may be provided to the result utilization device 104 that is scheduled to utilize the workload associated with the workload execution request 211. The execution request device 105 that has received the alert may retransmit the workload execution request 211 or reissue the workload execution request 211 after changing the content of the workload associated with the workload execution request 211.

After step 1910, the control may return to step 1901.

In step 1911 of FIG. 19, (in response to the determination result indicating that the workload associated with the workload execution request 211 can be deployed to the combination of the time zone and the data center 102 selected in the most recent step 1905,) the workload deployment setting unit 1900 stores a record indicating that a part of or the entire unallocated amounts (available amounts) calculated in step 1907 have been allocated to the workload in the workload deployment setting table 1200. Specifically, the workload deployment setting unit 1900 creates a record indicating that the content (for example, the amounts, specifically, the number of central processing units (CPUs), the number of graphics processing units (GPUs), and the capacity of the memory) of the IT resources used to process the workload associated with the workload execution request 211 has been allocated to the combination of the time zone (selected in the most recent step 1905) and the data center 102 corresponding to the unallocated amounts (available amounts), and stores the record in the workload deployment setting table 1200 illustrated in FIG. 12.

After step 1911, the control returns to step 1901, and the processing in the workload deployment setting unit 1900 is substantially in a standby state until the next new workload execution request 211 arrives.

### 6-7. Processing in Workload Deployment Control Information Transmission Unit (FIGS. 5, 12, and 13)

Information regarding the deployment setting 112 for deployment of the workload to the data center stored in the workload deployment setting table 1200 is delivered to the data center 102 to which the workload is to be deployed. The workload deployment control information transmission unit 512 serves to generate and transmit information (workload deployment control information 212 (WL-deploy)) used for the delivery.

The workload deployment control information transmission unit 512 may generate the workload deployment control information 212 (WL-deploy) addressed to the data center 102 to which the workload is to be deployed based on the information stored in the workload deployment setting table 1200 illustrated in FIG. 12. The workload deployment control information 212 (WL-deploy) may include information such as the identification information of the base 202 as the destination of the workload deployment control information 212 (WL-deploy), the identification information (data center identifier (DC-ID)) of the data center 102 as the destination, the identification information (workload identification number (WL-ID)) of the workload, the information regarding the execution start time or the scheduled execution start time of the processing of the workload, and the content (the number of central processing units (CPUs), the number of graphics processing units (GPU), and the capacity of the memory in the example of FIG. 12) of the IT resources used to process the workload.

The workload deployment control information transmission unit 512 transmits the generated workload deployment control information 212 (WL-deploy) to the data center 102 as the destination.

The processing performed by the workload deployment control information transmission unit 512 may be understood to form a “workload deployment control information transmission step”.

In addition to transmitting the workload deployment control information 212 (WL-deploy) to the data center 102, the workload deployment control information transmission unit 512 may store, in the workload execution history table 1300, a record indicating that the workload is deployed to the data center 102.

Referring to the example of FIG. 13, the workload deployment control information transmission unit 512 may store, in the workload execution history table 1300, a new record including pieces of information such as the identification information (workload identification number (WL-ID)) assigned to the workload, the identification information (data center identifier (DC-ID)) of the data center 102 as the destination (actual deployment destination data center) to which the workload has been actually deployed, the time at which the processing of the workload starts or the time at which the processing is scheduled to start (WL execution start time or scheduled WL execution start time), the number of central processing devices (CPU), the number of graphics processing units (GPU), and the capacity of memory that are scheduled to be allocated by the data center 102 as the deployment destination for the processing of the workload. The execution state (WL execution state) of the workload in the new record may be set to “under execution” if the processing of the workload immediately starts, and may be set to “standby for execution” if the processing of the workload is performed later.

Since the functions as described above are implemented by the workload deployment control information transmission unit 512, the information included in the record related to the workload associated with the workload execution request 211 stored in the workload deployment setting table 1200 can be delivered to the data center 102 to which the workload is to be deployed. Then, the data center 102 as the destination can process the workload associated with the workload execution request 211 after the workload is deployed. In addition, since the deployment of the workload to the data center 102 is reflected in the workload execution history table 1300, the system 101 can correctly grasp the information regarding the execution history and the execution state of the workload in each data center 102.

### 6-8. Processing in Workload Execution History Information Reception Unit (FIGS. 5 and 13)

The data center 102 to which the workload has been deployed may process the workload and transmit, as the workload execution history information 213 (WL-log), the information regarding the execution history and the execution state of the workload to the system 101. The workload execution history information 213 (WL-log) is received by the system 101, and then information included in the workload execution history information 213 (WL-log) is reflected in the workload execution history table 1300. The workload execution history information reception unit 513 is responsible for the reception and reflection.

For example, in a case where the received workload execution history information 213 (WL-log) indicates that the processing of any workload has ended (has been completed) in any one of the data centers 102, the workload execution history information reception unit 513 extracts pieces of information such as the identification information (workload identification number (WL-ID)) assigned to the workload and the end time (completion time) of the processing of the workload included in the workload execution history information 213 (WL-log). Then, the workload execution history information reception unit 513 specifies a record including the extracted workload identification number (WL-ID) from the workload execution history table 1300. The workload execution history information reception unit 513 stores information regarding the extracted end time (completion time) of the processing of the workload in the specified record, and changes the execution state (WL execution state) of the workload in the specified record to “completed”.

The processing performed by the workload execution history information reception unit 513 may be understood to form a “workload execution history information reception step”.

Since the functions as described above are implemented by the workload execution history information reception unit 513, for example, when the workload execution history information 213 (WL-log) indicating that the processing of the workload has ended (has been completed) is delivered from the data center 102 to the system 101, information indicated by the workload execution history information 213 (WL-log) can be reflected in the workload execution history table 1300. That is, the system 101 can correctly grasp the information regarding the execution history and the execution state of the workload in each data center 102.

### 6-9. Processing in Workload Redeployment Setting Unit (FIG. 20)

FIG. 20 is a flowchart of the processing performed by the workload redeployment setting unit 2000.

Hereinafter, the processing will be described in the order illustrated in FIG. 20. Each of processing steps performed by the workload redeployment setting unit 2000 in the flowchart of FIG. 20 may be understood to form a “workload redeployment setting step”.

Since the functions described below are implemented, when the operation mode 103 of any one of the data centers 102 is changed according to the data center operation mode plan 110, in a case where the changed operation mode 103 of the data center 102 and the “condition” when the workload deployed to the data center 102 is processed do not match each other, the workload can be redeployed (rebalanced or migrated) to another data center 102 where the mismatching does not occur. In this manner, it is possible to appropriately coordinate the control of each facility of the data center 102 based on the prediction 109 regarding the workload (the control by the setting of the operation mode 103) and the control of the deployment or the redeployment (rebalancing or migration) according to the “condition” when the workload associated with the actually received workload execution request 211 is processed.

In step 2001 of FIG. 20, the workload redeployment setting unit 2000 determines whether or not a timing of switching the time zone in the data center operation mode plan 110 has arrived. For example, in a case where each of the time zones is 1 hour (the length of the time zone is 1 hour) starting from 0 minutes and 0 seconds of every hour, the workload redeployment setting unit 2000 may set 0 minutes and 0 seconds of every hour as the timing of switching the time zone, and set a timing (for example, 58 minutes and 0 seconds of every hour (2 minutes before switching)) earlier than the timing of switching by a predetermined time as a timing at which affirmative determination is made in step 2001. If a determination result of step 2001 is affirmative, the control proceeds to step 2002. If the determination result of step 2001 is negative, step 2001 is repeated.

In step 2002 of FIG. 20, the workload redeployment setting unit 2000 selects one of records in which the execution state (WL execution state) of the workload remains (is expected to remain) as “under execution” during the switching of the time zone (for example, 0 minutes and 0 seconds of every hour) in the workload execution history table 1300. The workload redeployment setting unit 2000 acquires information regarding the selected record. The workload redeployment setting unit 2000 grasps the identification information (workload identification number) of the workload included in the acquired information of the record.

In step 2003 of FIG. 20, the workload redeployment setting unit 2000 specifies a record including the identification information (workload identification number) of the workload grasped in step 2002 from the workload execution request buffer table 1100. The workload redeployment setting unit 2000 acquires information regarding the specified record from the workload execution request buffer table 1100.

In step 2004 of FIG. 20, the workload redeployment setting unit 2000 grasps the constraint and the requirement imposed on the data center 102 serving as the processing subject when processing the workload included in the information regarding the record acquired from the workload execution request buffer table 1100 in step 2003.

Referring to the example of FIG. 11, the constraint and the requirement imposed on the data center 102 serving as the processing subject when processing the workload include the data center identifier (DC-ID) of the “deployable data center” and the level of the availability required when the workload is processed.

In step 2005 of FIG. 20, the workload redeployment setting unit 2000 grasps the identification information (data center identifier (DC-ID)) of the actual deployment destination data center included in the information regarding the record of the workload execution history table 1300 acquired in step 2002. The identification information (data center identifier (DC-ID)) of the actual deployment destination data center indicates the data center 102 to which the workload has been deployed before the workload is redeployed (rebalanced or migrated).

In step 2006 of FIG. 20, the workload redeployment setting unit 2000 specifies the operation mode 103 scheduled to be set in the actual deployment destination data center (the data center 102 to which the workload has been deployed before the redeployment (rebalancing or migration) of the workload is performed) grasped in step 2005 after the switching of the time zone. In addition, the workload redeployment setting unit 2000 also specifies the level of the availability achievable for the processing of the workload based on the specified operation mode 103. In order to perform the processing of step 2006, the workload redeployment setting unit 2000 may acquire information for specifying the operation mode 103 from the data center operation mode plan table 1000, and may acquire information for specifying the level of the availability achievable for the processing of the workload from the data center operation mode list table 700.

In step 2007 of FIG. 20, the workload redeployment setting unit 2000 determines whether or not the actual deployment destination data center (the data center 102 to which the workload has been deployed before the redeployment (rebalancing or migration) of the workload is performed) grasped in step 2004 after the switching of the time zone satisfies the constraint and the requirement imposed on the data center 102 serving as the processing subject when processing the workload grasped in step 2005. In general, in the constraint and the requirement imposed on the data center 102 serving as the processing subject when processing the workload, the constraint of the “deployable data center” is not changed due to the switching of the time zone. Therefore, the determination in step 2007 may be substantially a comparison determination between the level of the availability required when the workload is processed, which is grasped in step 2004, and the level of the availability achievable for the processing of the workload after the switching of the time zone, which is grasped in step 2006. If a determination result of step 2007 is affirmative, no redeployment (rebalancing or migration) is required for the workload associated with the record most recently selected in step 2002 and the control proceeds to step 2008. If the determination result of step 2007 is negative, the control proceeds to step 2009 to redeploy (rebalance or migrate) the workload associated with the record most recently selected in step 2002.

In step 2008 of FIG. 20, the workload redeployment setting unit 2000 determines whether or not all the records in which the execution state (WL execution state) of the workload remains (is expected to remain) “under execution” during the switching of the time zone (for example, 0 minutes and 0 seconds of every hour) have been selected in step 2002 in the workload execution history table 1300. If a determination result of step 2008 is affirmative, the control returns to 2001, and the processing in the workload redeployment setting unit 2000 is substantially in a standby state until the next timing of switching the time zone arrives. If the determination result of step 2008 is negative, the control returns to step 2002 to newly select a record that has not yet been selected.

In step 2009 of FIG. 20, the workload redeployment setting unit 2000 specifies the data center 102 which satisfies the constraint and the requirement imposed on the data center 102 serving as the processing subject when processing the workload grasped in step 2004 after the switching of the time zone and to which the content (for example, the amount such as the number of central processing units (CPUs), the number of graphics processing units (GPUs), and the capacity of the memory) of the IT resources used when processing the workload and the time can be allocated.

In performing the processing of step 2009, the workload redeployment setting unit 2000 may acquire, from the data center list table 600, information regarding the content (for example, the amounts such as the number of central processing units (CPUs), the number of graphics processing units (GPUs), and the capacity of the memory) of the IT resources held by each of the data centers 102. In performing the processing of step 2009, the workload redeployment setting unit 2000 may acquire, from the data center operation mode plan table 1000, information regarding the operation mode 103 scheduled to be set in each of the data centers 102 after the switching of the time zone. In performing the processing of step 2009, the workload redeployment setting unit 2000 may acquire, from the data center operation mode list table 700, information regarding the level of the availability achievable when performing the processing of the workload, corresponding to the operation mode 103 scheduled to be set in each data center 102 after the switching of the time zone, and information regarding the proportion of the content (amount) of the IT resources providable for the processing of the workload in the content (amounts) of the held IT resources. In performing the processing of step 2009, the workload redeployment setting unit 2000 may acquire, from the workload execution history table 1300, information regarding a state of the allocation of the IT resources to the workload to be deployed in each of the data centers 102 after the switching of the time zone.

In step 2010 of FIG. 20, the workload redeployment setting unit 2000 creates a record indicating that the deployment destination data center is changed (migrated) for the workload associated with the workload identification number (WL-ID) of the record acquired when step 2002 is most recently performed according to the switching of the time zone. The workload redeployment setting unit 2000 stores the created record in the workload redeployment setting table 1400. Referring to the example of FIG. 14, the created record includes pieces of information such as the identification information (workload identification number (WL-ID)) assigned to the workload, the identification information (data center identifier (DC-ID)) of the deployment destination data center (the data center under deployment) before the redeployment, the identification information (data center identifier (DC-ID)) of the redeployment destination data center, the time at which the redeployment is scheduled to be performed (scheduled redeployment time), and the content of the IT resources (mainly the amounts of the IT resources in the example of FIG. 14) allocated by the data center 102 as the redeployment destination for the processing of the workload. Here, the content of the IT resources (mainly the amounts of the IT resources in the example of FIG. 14) allocated by the data center 102 as the redeployment destination for the processing of the workload may include information regarding the number of central processing units (CPUs), the number of graphics processing units (GPUs), and the capacity of the memory.

In step 2010, the workload redeployment setting unit 2000 may correct a content of the workload deployment setting table 1200 as necessary. Referring to the example of FIG. 12, in the record for the workload to be redeployed (rebalanced or migrated), the data center identifier (DC-ID) of the actual deployment destination data center may be corrected to indicate the data center 102 as the redeployment destination.

In step 2011 of FIG. 20, the workload redeployment setting unit 2000 determines whether or not all the records in which the execution state (WL execution state) of the workload remains (is expected to remain) “under execution” during the switching of the time zone (for example, 0 minutes and 0 seconds of every hour) have been selected in step 2002 in the workload execution history table 1300. If a determination result of step 2011 is affirmative, the control returns to 2001, and the processing in the workload redeployment setting unit 2000 is substantially in a standby state until the next timing of switching the time zone arrives. If the determination result of step 2011 is negative, the control returns to step 2002 to newly select a record that has not yet been selected.

### 6-10. Processing in Workload Redeployment Control Information Transmission Unit (FIG. 5, FIG. 13, FIG. 14)

Information indicating that the data center as the deployment destination of the workload is to be changed, which is stored in the workload redeployment setting table 1400, may be delivered to both the data center 102 as the deployment destination before the redeployment and the data center 102 as the redeployment destination. The workload redeployment control information transmission unit 514 serves to generate and transmit information (workload redeployment control information 214 (WL-migration)) used for the delivery.

The workload redeployment control information transmission unit 514 may generate the workload redeployment control information 214 (WL-migration) addressed to both the data center 102 as the deployment destination before the redeployment and the data center 102 as the redeployment destination based on the information stored in the workload redeployment setting table 1400 illustrated in FIG. 14. The workload redeployment control information 214 (WL-migration) may include pieces of information such as the identification information of the base (or bases) 202 as the destination of the workload redeployment control information 214 (WL-migration), the identification information (data center identifier (DC-ID)) of the data center 102 as the destination, the identification information (workload identification number (WL-ID)) of the workload, information regarding a scheduled time of the redeployment of the workload, and the content (the number of central processing units (CPUs), the number of graphics processing units (GPU), and the capacity of the memory in the example of FIG. 14) of the IT resources used to process the workload in the data center 102 as the redeployment destination.

The workload redeployment control information transmission unit 514 transmits the generated workload redeployment control information 214 (WL-migration) to the data center (data centers) 102 as the destination.

The processing performed by the workload redeployment control information transmission unit 514 may be understood to form a “workload redeployment control information transmission step”.

In addition to transmitting the workload redeployment control information 214 (WL-migration) to the data center (data centers) 102, the workload redeployment control information transmission unit 514 may change the record of the workload execution history table 1300 to indicate that the data center 102 as the deployment destination of the workload is to be changed.

Referring to the example of FIG. 13, the workload redeployment control information transmission unit 514 may change the data center identifier (DC-ID) of the actual deployment destination data center to indicate the data center 102 as the redeployment destination for the record for the workload to be redeployed (rebalanced or migrated) in the workload execution history table 1300.

Since the functions as described above are implemented by the workload redeployment control information transmission unit 514, the information indicating that the data center 102 as the redeployment destination of the workload is to be changed, which is stored in the workload redeployment setting table 1400, can be delivered to both the data center 102 as the deployment destination before the redeployment and the data center 102 as the redeployment destination. Then, the data center 102 as the destination can operate to implement the redeployment (rebalancing or migration) of the workload. In addition, since the redeployment (rebalancing or migration) of the workload is reflected in the workload execution history table 1300, the system 101 can correctly grasp the information regarding the execution history and the execution state of the workload in each data center 102.

### 7. OTHERS (MODIFIED EXAMPLES)

The present disclosure is not limited to the above embodiment but includes various modified examples. Some of the configurations and the steps of processing according to the embodiment may be replaced with configurations and steps of processing according to other possible embodiments. The configurations and the steps of processing according to other possible embodiments may be added to the configurations and the steps of processing according to the embodiment.

For example, the present disclosure can include the following modified examples of the embodiment.

### (Modified Example A) Workload Deployment Setting Distribution Processing

In the above description, a case where the system 101 performs the control in allocating (deploying) the workload to the information processing resource in a centralized manner has been mainly described.

However, the system 101 does not have to perform the control in allocating (deploying) the workload to the information processing resource in a centralized manner. For example, the workload execution request 211 from any one of the execution request devices 105 in FIG. 1 may be received by any one of the data centers 102 without passing through the system 101. The data center 102 itself that has received the workload execution request 211 may determine whether or not the data center 102 can process the workload associated with the workload execution request 211. If the data center 102 cannot process the workload associated with the workload execution request 211 by itself, the data center 102 may transfer the workload execution request 211 to the data center 102 that can process (or possibly can process) the workload associated with the workload execution request 211.

In this manner, it is also possible to implement the control in allocating (deploying) the workload to the information processing resource in a distributed manner. In this case, the workload deployment setting unit 1900 does not have to exist in the system 101.

In the modified example as described above, the functional configuration of the system 101 can be made simpler.

### (Modified Example B) Modified Example of Condition When Processing Workload

In the above description, the condition when processing the workload includes the “deployable data center” as the constraint, the level of the availability required when processing the workload as the requirement, the content (mainly the amounts such as the number of central processing units (CPUs), the number of graphics processing units (GPUs), and the capacity of the memory) of the information processing resources (IT resources), the estimated required time, and the allowable execution delay time.

In the modified example, the condition when processing the workload may include only some of those listed above, or may include those other than those listed above.

In the modified example, it is possible to flexibly set the condition when processing the workload.

### (Modified Example C) Modified Example of “Deployable Data Center”

In the above description, the “deployable data center”, that is, the data center 102 to which the workload can be deployed if another condition (a constraint, a requirement, the amounts of available IT resources that can be allocated, or the like) is satisfied, is determined based on a geographical relationship between the result utilization device 104, which is a device using a result of the processing of the workload associated with the workload execution request 211, and the data center 102 (for example, a relationship such as a physical distance for personnel to go to the base 202 where the data center 102 exists when a failure occurs in the data center 102) or a connection relationship on the network 299 (for example, a relationship indicating the degree of closeness on a network topology in the network 299 and a delay time of information delivery in the network 299). In the example of FIG. 2, in a case where a result utilization device 104-U-1-1-1-1 is a device using the result of the processing of the workload associated with the workload execution request 211, a group of the data centers 102 in the edge (zone) base 202-E-1-1 in a zone where the result utilization device 104-U-1-1-1-1 exists, a group of the data centers 102 in the regional base 202-R-1 installed in a region where the result utilization device 104-U-1-1-1-1 exists, and a group of the data centers 102 in the core base 202-C can be the “deployable data centers”, and a group of the data centers 102 in the edge (zone) base 202-E-1-2 for another zone and a group of the data centers 102 in the regional base 202-R-2 for another region are not necessarily the “deployable data centers”.

Since the “deployable data center” is set as described above, the workload can be deployed only to the data center 102 having a favorable geographical condition and the data center 102 having a favorable connection relationship on the network 299 when viewed from the result utilization device 104 which is a device using the result of the processing of the workload associated with the workload execution request 211. As a result, for example, it can be expected that a time until the result of the processing of the workload is received as a response is shortened.

However, the setting of the “deployable data center” may be performed more flexibly. For example, not only a zone or a region to which the result utilization device 104 which is a device using the result of the processing of the workload associated with the workload execution request 211 belongs, but also the data center 102 in the base 202 associated with any one of a plurality of zones or a plurality of regions may be set as the “deployable data center”.

In the modified example, the “deployable data center” can be flexibly set, so that options of the data center 102 as the deployment destination of the workload are widened.

### (Modified Example D) Management of Performance Information of Information Processing Resource (IT Resource)

In the embodiment described above, the number and the amounts of information processing resources (IT resources) of each data center 102 are explicitly managed as shown in the data center list table 600 of FIG. 6, the workload actual record table 800 of FIG. 8, the workload prediction table 900 of FIG. 9, the workload execution request buffer table 1100 of FIG. 11, the workload deployment setting table 1200 of FIG. 12, the workload execution history table 1300 of FIG. 13, and the workload redeployment setting table 1400 of FIG. 14. For example, in the figure pointed out above, the number of central processing units (CPUs), the number of graphics processing units (GPUs), and the capacity of the memory included in the data center 102 are explicitly managed.

In the modified example, in addition to the number and the amounts of the information processing resources (IT resources) of each data center 102 being explicitly managed, performance of the IT resources of each data center 102 may also be explicitly managed. For example, one or more of a generation representing the performance of the central processing unit (CPU) included in each of the data centers 102, a generation representing the performance of the graphics processing unit (GPU), an access speed representing the performance of the memory, and the like may be managed in each of the figures pointed out above.

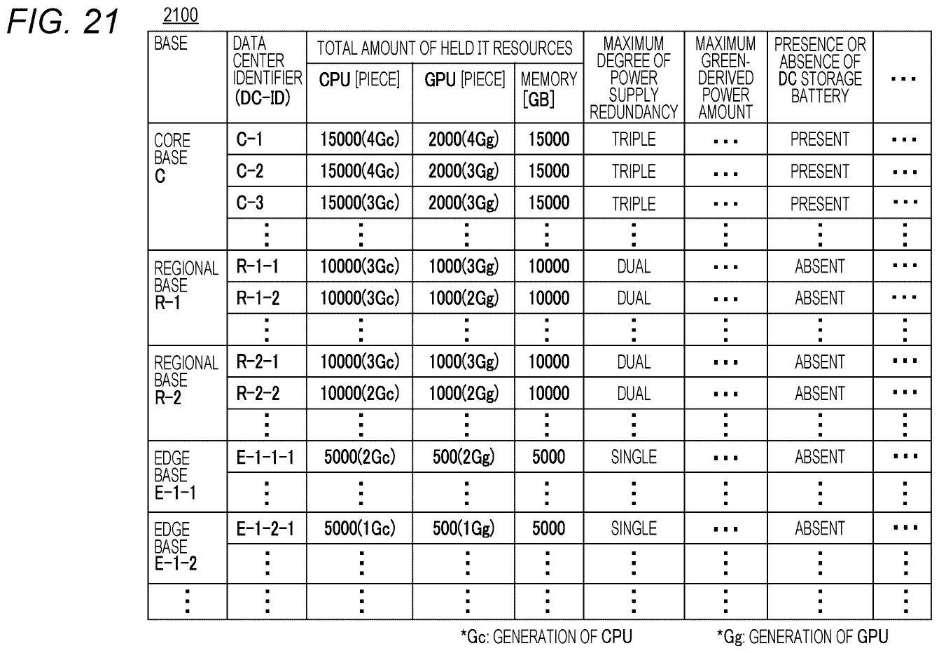

FIG. 21 illustrates, as the modified example, a modified data center list table 2100 which is a data center list table in the modified example in which the generation representing the performance of the central processing unit (CPU) and the generation representing the performance of the graphics processing unit (GPU) are managed. In FIG. 21, the generation representing the performance of the central processing unit (CPU) is denoted by “Gc”. In FIG. 21, the generation representing the performance of the graphics processing unit (GPU) is denoted by “Gg”. As illustrated in FIG. 21, information indicating the generation may be managed in addition to the number of one or both of the central processing units (CPU) and the graphics processing units (GPU) held by each of the data centers 102. (Although not illustrated in FIG. 21, information indicating the access speed of the memory or the like may also be managed.)

Similarly to FIG. 21 as the modified example of FIG. 6, the information indicating the generation may be managed in addition to the number of one or both of the central processing units (CPU) and the graphics processing units (GPU) in FIGS. 8, 9, 11, 12, 13, and 14. (The information indicating the access speed of the memory or the like may also be managed.)

In such a modified example, not only the number and the amounts of the information processing resources (IT resources) but also one or more of the performances of the information processing resources (IT resources) (for example, the generation of the central processing unit (CPU), the generation of the graphics processing unit (GPU), the access speed of the memory, and the like) may be considered in creating the prediction 109 regarding the workload, creating the data center operation mode plan 110, performing the deployment setting 112 for deployment of the workload to the data center, and further performing the redeployment of the workload to the data center.

According to the above modified example, it is possible to implement the prediction 109 regarding the workload, the data center operation mode plan 110, and the deployment setting 112 for deployment of the workload to the data center that are more appropriate based on the performance of the information processing resource (IT resource).

### (Modified Example E) Modified Example Not Using Estimated Required Time Related to Processing of Workload

In the embodiment described above, the workload execution request reception unit 511 acquires information regarding the estimated required time related to the processing of the workload or determines the estimated required time, and then stores the information regarding the estimated required time in the record of the workload execution request buffer table 1100. Then, after grasping the information regarding the estimated required time in step 1902 of FIG. 19, the workload deployment setting unit 1900 determines whether or not the workload can be deployed to the data center 102 by using the information regarding the estimated required time in step 1908 of FIG. 19.

In the modified example, the estimated required time related to the processing of the workload does not have to be used. For example, there can be a case where it is difficult to determine the estimated required time related to the processing of the workload indicated by the workload execution request 211 depending on the workload execution request 211 received by the system 101. Therefore, in the modified example, the workload execution request reception unit 511 does not have to handle the information regarding the estimated required time and does not have to store the information regarding the estimated required time in the record of the workload execution request buffer table 1100. Accordingly, the workload deployment setting unit 1900 does not have to grasp the information regarding the estimated required time. In this case, the workload deployment setting unit 1900 may perform determination by temporarily determining the estimated required time in a step similar to step 1908 of FIG. 19. Alternatively, the workload deployment setting unit 1900 may perform determination in a step similar to step 1908 in FIG. 19 without considering the time.

According to such a modified example, even in a case where it is difficult to determine the estimated required time related to the processing of the workload indicated by the workload execution request 211, the deployment setting 112 for deployment of the workload to the data center can be implemented.

### (Modified Example F) Modified Example in which Notation of Deployable Data Center is Replaced with Notation of Base

In the embodiment described above, in the record of each of the workload actual record table 800 of FIG. 8, the workload prediction table 900 of FIG. 9, and the workload execution request buffer table 1100 of FIG. 11, the “deployable data center” is directly indicated by the data center identification information (DC-ID) of each data center 102.

In the modified example, the “deployable data center” may be indirectly indicated by the identification information of the base 202 where the data center 102 exists. For example, in a case where a group of the data centers 102 existing in the regional base 202-R-1 in FIG. 2 is included in the “deployable data centers”, the “deployable data center” may be denoted by “R-1”, which is the identification information of the regional base 202-R-1, instead of being denoted by “R-1-1”, “R-1-2”, or the like, which is the data center identification information (DC-ID) of the individual data center 102 such as the data center 102-R-1-1 or the data center 102-R-1-2. In a case where whether or not each of the data centers 102 is the “deployable data center” is determined based on the geographical condition or the like, and there is no possibility that the data center 102 that is the “deployable data center” and the data center 102 that is not the “deployable data center” coexist in one base 202 in principle, the “deployable data center” can be represented by the identification information of the base 202.

According to such a modified example, the information indicating the “deployable data center” can be simplified. In addition, when the user of the system 101 or the like browses the information included in the table group pointed out above, the information indicating the “deployable data center” is easy to use (easy to understand at the time of browsing).

The technical matters described in each of the embodiment of the present disclosure and the modified examples of the embodiment described above can be appropriately combined as long as no technical contradiction occurs.

What is claimed is:

1. A system comprising
a data center operation mode plan creation unit that creates a data center operation mode plan, which is a plan of an operation mode of each of data centers, based on a prediction regarding a workload requested to be processed in any one of the data centers.

2. The system according to claim 1, further comprising
a workload deployment setting unit that determines, in response to reception of the workload execution request, the data center to which the workload associated with a received workload execution request for requesting processing of the workload in any one of the data centers is to be deployed, based on a condition when the workload associated with the received workload execution request is processed and on the operation mode of each of the data centers determined according to the data center operation mode plan.

3. The system according to claim 2, further comprising
a workload redeployment setting unit that determines another data center satisfying the condition, in a case where the operation mode of any one of the data centers is changed based on the data center operation mode plan and the changed operation mode of the data center whose operation mode has been changed does not satisfy the condition when the workload deployed to the data center is processed, the other data center being determined as a data center to which the workload is to be redeployed.

4. The system according to claim 1, wherein
each operation mode of each of the data centers is associated with information regarding a level of availability achievable when the data center is in the operation mode and information regarding a content providable to the workload among contents of information processing resources held by the data center when the data center is in the operation mode.

5. The system according to claim 4, wherein
each operation mode of each of the data centers is further associated with information for controlling a facility related to the data center for achieving the level of the availability.

6. The system according to claim 5, wherein
the information for controlling the facility is one or more of control information regarding air conditioning for the data center, control information regarding a storage battery for the data center, and control information regarding an emergency generator for the data center.

7. The system according to claim 4, wherein
each operation mode of each of the data centers is associated with information regarding values of one or more types of indices when the data center is in the operation mode, and
the data center operation mode plan creation unit creates the data center operation mode plan by using a combination of the operation modes in which the values of the indices are relatively favorable among combinations of the operation modes of the respective data centers configured to process each workload indicated by the prediction related to the workload.

8. The system according to claim 7, wherein
there are three types of indices in the indices,
a priority level to be considered when the data center operation mode plan creation unit determines the combination of the operation modes of the respective data centers is set for each type of the indices, and
the respective indices are a cost, a ratio of an amount of power generated with a relatively low carbon emission, and an index related to adjustment compensation, in descending order of the priority level.

9. The system according to claim 2, wherein
information indicating the condition when the workload is processed includes information for identifying the data center to which the workload is deployable if another condition is satisfied, information indicating a level of availability required when the workload is processed, and information indicating a content of an information processing resources required when the workload is processed.

10. The system according to claim 9, wherein
the data center exists in each of a core base, a regional base disposed for each region, and an edge base existing in a zone narrower than the region,
a result utilization device which is a device using a result of the processing of the workload associated with the workload execution request is positioned in any zone, and
the information for identifying the data center to which the workload is deployable if another condition is satisfied is determined based on a geographical relationship between the result utilization device related to the workload and the data center or based on a connection relationship on a network.

11. The system according to claim 9, wherein
the information indicating the condition when the workload is processed further includes information indicating a time by which a delay is allowed when the workload is processed.

12. The system according to claim 1, further comprising
a workload prediction unit that creates the prediction regarding the workload based on an actual record of reception of a workload execution request for requesting processing of the workload in any one of the data centers.

13. The system according to claim 3, wherein
the system further comprises a workload prediction unit, a data center operation mode control information transmission unit, a workload execution request reception unit, a workload deployment control information transmission unit, a workload execution history information reception unit, a workload redeployment control information transmission unit, and a workload actual record table creation unit, and
the system further comprises a data center list table, a data center operation mode list table, a workload prediction table, a data center operation mode plan table, a workload execution request buffer table, a workload deployment setting table, a workload execution history table, and a workload redeployment setting table.

14. A system-implemented method comprising
a data center operation mode plan creation step of creating a data center operation mode plan, which is a plan of an operation mode of each of data centers, based on a prediction regarding a workload requested to be processed in any one of the data centers.

15. A program for causing a system to perform
a data center operation mode plan creation step of creating a data center operation mode plan, which is a plan of an operation mode of each of data centers, based on a prediction regarding a workload requested to be processed in any one of the data centers.
